(19) United States
(12) Patent Application Publication
(10) Pub. No.: US 2026/0179537 A1
(43) Pub. Date: Jun. 25, 2026

(54) EMISSION DRIVER, DISPLAY DEVICE INCLUDING THE EMISSION DRIVER, AND ELECTRONIC DEVICE INCLUDING THE DISPLAY DEVICE

(71) Applicant: Samsung Display Co., LTD., Yongin-si (KR)

(72) Inventors: SEHYUN LEE, Yongin-si (KR); KYUNGHOON CHUNG, Yongin-si (KR); KWIHYUN KIM, Yongin-si (KR); JI-SUN KIM, Yongin-si (KR); SUNHWA LEE, Yongin-si (KR)

(21) Appl. No.: 19/356,363

(22) Filed: Oct. 13, 2025

(30) Foreign Application Priority Data
Dec. 20, 2024 (KR) 10-2024-0192478

(51) Int. Cl. G09G 3/32

(52) U.S. Cl. CPC G09G 3/32; G09G 2310/08; G09G 2320/0633

(57) ABSTRACT

An emission driver is selectively driven in either a low luminance mode or a high luminance mode such that a pulse width of an emission signal may be finely controlled, and a maximum luminance expressed by a light emitting element may be finely controlled.

This application claims priority to Korean Patent Application No. 10-2024-0192478, filed on Dec. 20, 2024, and all the benefits accruing therefrom under 35 U.S.C. § 119, the content of which in its entirety is herein incorporated by reference.

### BACKGROUND

### 1. Field

Embodiments of the invention relate to an emission driver, a display device including the emission driver, and an electronic device including the display device. More particularly, embodiments of the invention relate to an emission driver, a display device including the emission driver, and an electronic device including the display device for generating an emission signal provided to a pixel including a light emitting element driven by an impulse pulse amplitude modulation (PAM) method.

### 2. Description of the Related Art

A pixel may include a light emitting element. A method of driving a light emitting element such as a micro light emitting diode (μLED), an organic light emitting diode (OLED), etc. may include an Impulse PAM method. In the Impulse PAM method, a generation time (or a pulse width) of a driving current provided to the light emitting element may be adjusted to express a maximum luminance, and an amount (or amplitude) of the driving current may be adjusted to express a grayscale.

### SUMMARY

In a case where a light emitting element of a pixel is driven in an Impulse PAM method, the generation time of the driving current may be desired to be finely controlled to finely control a maximum luminance of the light emitting element. In this case, since the generation time of the driving current is determined based on a pulse width of the emission signal, the pulse width of the emission signal may be desired to be finely controlled. In particular, in order to express the maximum luminance in a low luminance mode, the pulse width of the emission signal may be desired to be more finely controlled.

Embodiments of the invention provide an emission driver for finely controlling a pulse width of an emission signal.

Embodiments of the invention provide a display device including the emission driver.

Embodiments of the invention provide an electronic device including the display device.

In an embodiment of an emission driver according to the invention, the emission driver includes a plurality of stages. In such an embodiment, each of the stages includes a first transistor including a gate electrode which receives a first clock signal, a first electrode which receives an input signal, and a second electrode connected to a first node, a second transistor including a gate electrode connected to the first node, a first electrode which receives the first clock signal, and a second electrode connected to a second node, a third transistor including a gate electrode which receives the first clock signal, a first electrode which receives a low gate voltage, and a second electrode connected to the second node, a fourth transistor including a gate electrode connected to the second node, a first electrode which receives a high gate voltage, and a second electrode connected to a third node, a fifth transistor including a first electrode connected to the first node, a first electrode which receives a second clock signal, and a second electrode connected to the third node, a sixth transistor including a gate electrode which receives the low gate voltage, a first electrode connected to the second node, and a second electrode connected to a fourth node, a seventh transistor including a gate electrode connected to the fourth node, a first electrode which receives the second clock signal, and a second electrode connected to a fifth node, an eighth transistor including a gate electrode which receives the second clock signal, a first electrode connected to the fifth node, and a second electrode connected to an inversion control node, a ninth transistor including a gate electrode which receives a first selection signal, a first electrode, and a second electrode connected to the inversion control node, an eleventh transistor including a gate electrode which receives a second selection signal, a first electrode which receives the high gate voltage, and a second electrode, a twelfth transistor including a gate electrode connected to the first node, a first electrode connected to the second electrode of the eleventh transistor, and a second electrode connected to the inversion control node, a thirteenth transistor including a gate electrode which receives the low gate voltage, a first electrode connected to the first node, and a second electrode connected to a control node, a fourteenth transistor including a gate electrode connected to the inversion control node, a first electrode which receives the high gate voltage, and a second electrode connected to an emission output node from which an emission signal is output, and a fifteenth transistor including a gate electrode connected to the control node, a first electrode, and a second electrode connected to the emission output node.

In an embodiment, each of the stages may further include a tenth transistor including a gate electrode which receives a reset signal, a first electrode which receives the high gate voltage, and a second electrode connected to the first node.

In an embodiment, each of the stages may further include a first capacitor including a first electrode connected to the first node and a second electrode connected to the third node, a second capacitor including a first electrode connected to the fourth node and a second electrode connected to the fifth node, and a third capacitor including a first electrode which receives the high gate voltage and a second electrode connected to the inversion control node.

In an embodiment, the first electrode of the ninth transistor may be connected to the second node.

In an embodiment, the first electrode of the ninth transistor may be connected to the fourth node.

In an embodiment, the ninth transistor and the eleventh transistor may be p-channel metal-oxide-semiconductor (PMOS) transistors.

In an embodiment, the ninth transistor and the eleventh transistor may be n-channel metal-oxide-semiconductor (NMOS) transistors.

In an embodiment, the ninth transistor may include two sub-transistors which are connected in series and gate electrodes of which are connected to each other.

In an embodiment, the eleventh transistor may include two sub-transistors which are connected in series and gate electrodes of which are connected to each other.

In an embodiment, in a low luminance mode, the first selection signal may have an activation level, and the second selection signal has a deactivation level. In such an embodiment, in a high luminance mode, the first selection signal has the deactivation level, and the second selection signal has the activation level.

In an embodiment, in the low luminance mode, the first electrode of the fifteenth transistor may receive the second clock signal. In such an embodiment, in the high luminance mode, the first electrode of the fifteenth transistor may receive the low gate voltage.

In an embodiment, the input signal may be an emission start signal or a previous emission signal. In such an embodiment, in the low luminance mode, the emission start signal may be a low luminance emission start signal. In the high luminance mode, the emission start signal may be a high luminance emission start signal different from the low luminance emission start signal.

In an embodiment, a length of a low level of the low luminance emission start signal may be less than a length of a high level of the high luminance emission start signal.

In an embodiment, a length of an activation level of the emission signal in the low luminance mode may be less than a length of an activation level of the emission signal in the high luminance mode.

In an embodiment of a display device according to the invention, the display device includes a display panel including a pixel, a data driver which provides a data voltage to the pixel, a gate driver which provides a gate signal to the pixel, an emission driver which provides an emission signal to the pixel, and a driving controller which controls the data driver, the gate driver, and the emission driver. In such an embodiment, the emission driver includes a plurality of stages. In such an embodiment, each of the stages includes a first transistor including a gate electrode which receives a first clock signal, a first electrode which receives an input signal, and a second electrode connected to a first node, a second transistor including a gate electrode connected to the first node, a first electrode which receives the first clock signal, and a second electrode connected to a second node, a third transistor including a gate electrode which receives the first clock signal, a first electrode which receives a low gate voltage, and a second electrode connected to the second node, a fourth transistor including a gate electrode connected to the second node, a first electrode which receives a high gate voltage, and a second electrode connected to a third node, a fifth transistor including a first electrode connected to the first node, a first electrode which receives a second clock signal, and a second electrode connected to the third node, a sixth transistor including a gate electrode which receives the low gate voltage, a first electrode connected to the second node, and a second electrode connected to a fourth node, a seventh transistor including a gate electrode connected to the fourth node, a first electrode which receives the second clock signal, and a second electrode connected to a fifth node, an eighth transistor including a gate electrode which receives the second clock signal, a first electrode connected to the fifth node, and a second electrode connected to an inversion control node, a ninth transistor including a gate electrode which receives a first selection signal, a first electrode, and a second electrode connected to the inversion control node, an eleventh transistor including a gate electrode which receives a second selection signal, a first electrode which receives the high gate voltage, and a second electrode, a twelfth transistor including a gate electrode connected to the first node, a first electrode connected to the second electrode of the eleventh transistor, and a second electrode connected to the inversion control node, a thirteenth transistor including a gate electrode which receives the low gate voltage, a first electrode connected to the first node, and a second electrode connected to a control node, a fourteenth transistor including a gate electrode connected to the inversion control node, a first electrode which receives the high gate voltage, and a second electrode connected to an emission output node from which an emission signal is output, and a fifteenth transistor including a gate electrode connected to the control node, a first electrode, and a second electrode connected to the emission output node.

In an embodiment, each of the stages may further include a tenth transistor including a gate electrode which receives a reset signal, a first electrode which receives the high gate voltage, and a second electrode connected to the first node.

In an embodiment, each of the stages may further include a first capacitor including a first electrode connected to the first node and a second electrode connected to the third node, a second capacitor including a first electrode connected to the fourth node and a second electrode connected to the fifth node, and a third capacitor including a first electrode which receives the high gate voltage and a second electrode connected to the inversion control node.

In an embodiment, the first electrode of the ninth transistor may be connected to the second node.

In an embodiment, the first electrode of the ninth transistor may be connected to the fourth node.

In an embodiment of an electronic device according to the invention, the electronic device includes a display panel including a pixel, a data driver which provides a data voltage to the pixel, a gate driver which provides a gate signal to the pixel, an emission driver which provides an emission signal to the pixel, a driving controller which controls the data driver, the gate driver, and the emission driver, and a processor which control the driving controller. In such an embodiment, The emission driver includes a plurality of stages. In such an embodiment, each of the stages includes a first transistor including a gate electrode which receives a first clock signal, a first electrode which receives an input signal, and a second electrode connected to a first node, a second transistor including a gate electrode connected to the first node, a first electrode which receives the first clock signal, and a second electrode connected to a second node, a third transistor including a gate electrode which receives the first clock signal, a first electrode which receives a low gate voltage, and a second electrode connected to the second node, a fourth transistor including a gate electrode connected to the second node, a first electrode which receives a high gate voltage, and a second electrode connected to a third node, a fifth transistor including a first electrode connected to the first node, a first electrode which receives a second clock signal, and a second electrode connected to the third node, a sixth transistor including a gate electrode which receives the low gate voltage, a first electrode connected to the second node, and a second electrode connected to a fourth node, a seventh transistor including a gate electrode connected to the fourth node, a first electrode which receives the second clock signal, and a second electrode connected to a fifth node, an eighth transistor including a gate electrode which receives the second clock signal, a first electrode connected to the fifth node, and a second electrode connected to an inversion control node, a ninth transistor including a gate electrode which receives a first selection signal, a first electrode, and a second electrode connected to the inversion control node, an eleventh transistor including a gate electrode which receives a second selection signal, a first electrode which receives the high gate voltage, and a second electrode, a twelfth transistor including a gate electrode connected to the first node, a first electrode connected to the second electrode of the eleventh transistor, and a second electrode connected to the inversion control node, a thirteenth transistor including a gate electrode which receives the low gate voltage, a first electrode connected to the first node, and a second electrode connected to a control node, a fourteenth transistor including a gate electrode connected to the inversion control node, a first electrode which receives the high gate voltage, and a second electrode connected to an emission output node from which an emission signal is output, and a fifteenth transistor including a gate electrode connected to the control node, a first electrode, and a second electrode connected to the emission output node.

According to embodiments of the emission driver, the display device, and the electronic device, the emission driver may be selectively driven according to a low luminance mode or a high luminance mode. Accordingly, a pulse width of an emission signal may be finely controlled, and a maximum luminance expressed by a light emitting element may be finely controlled.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram showing a display device according to embodiments of the invention;

FIG. 2 is a block diagram showing an emission driver of FIG. 1;

FIG. 3 is a signal timing diagram showing an operation of an emission driver of FIG. 2 in a low luminance mode;

FIG. 4 is a signal timing diagram showing an operation of an emission driver of FIG. 2 in a high luminance mode;

FIG. 5A is a circuit diagram showing an example of a stage of FIG. 2 in a low luminance mode;

FIG. 5B is a signal timing diagram showing an input signal, a first clock signal, a second clock signal, a voltage of a control node, a voltage of an inversion control node, and an emission signal of FIG. 5A;

FIG. 5C is a circuit diagram showing an operation of a stage of FIG. 5A in a first duration of FIG. 5B;

FIG. 5D is a circuit diagram showing an operation of a stage of FIG. 5A in a second duration of FIG. 5B;

FIG. 5E is a circuit diagram showing an operation of a stage of FIG. 5A in a third duration of FIG. 5B;

FIG. 6A is a circuit diagram showing an example of a stage of FIG. 2 in a high luminance mode;

FIG. 6B is a signal timing diagram showing an input signal, a first clock signal, a second clock signal, a voltage of a control node, a voltage of an inversion control node, and an emission signal of FIG. 6A;

FIG. 6C is a circuit diagram showing an operation of a stage of FIG. 6A in a first duration of FIG. 6B;

FIG. 6D is a circuit diagram showing an operation of a stage of FIG. 6A in a second duration of FIG. 6B;

FIG. 6E is a circuit diagram showing an operation of a stage of FIG. 6A in a third duration of FIG. 6B;

FIG. 6F is a circuit diagram showing an operation of a stage of FIG. 6A in a fourth duration of FIG. 6B;

FIG. 6G is a circuit diagram showing an operation of a stage of FIG. 6A in a fifth duration of FIG. 6B;

FIG. 6H is a circuit diagram showing an operation of a stage of FIG. 6A in a sixth duration of FIG. 6B;

FIG. 6I is a circuit diagram showing an operation of a stage of FIG. 6A in a seventh duration of FIG. 6B;

FIG. 6J is a circuit diagram showing an operation of a stage of FIG. 6A in an eighth duration of FIG. 6B;

FIG. 6K is a circuit diagram showing an operation of a stage of FIG. 6A in a ninth duration of FIG. 6B;

FIG. 7 is a block diagram showing an embodiment of an electronic device; and

FIG. 8 is a diagram showing an embodiment in which an electronic device of FIG. 7 is implemented as a smart watch.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

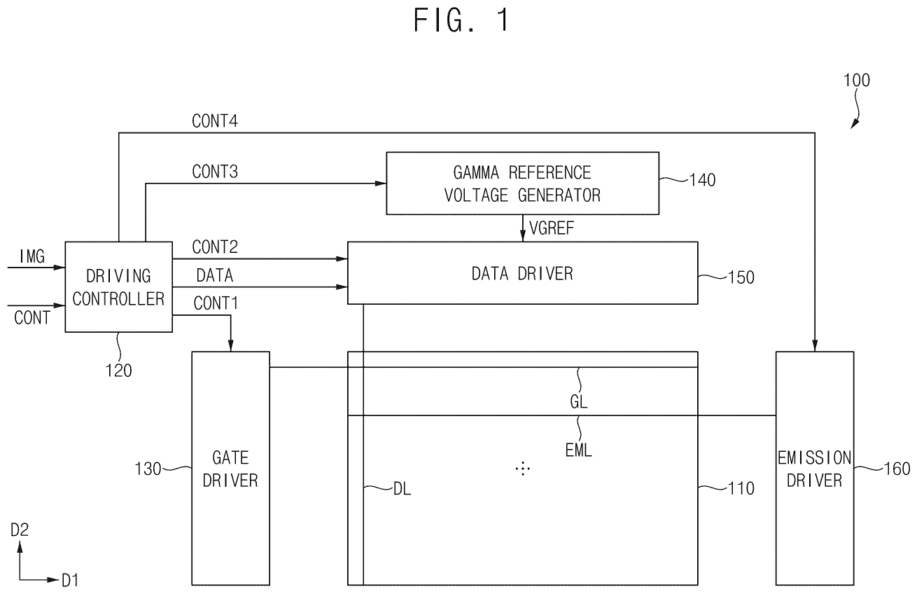

FIG. 1 is a block diagram showing a display device 100 according to embodiments of the invention.

Referring to FIG. 1, an embodiment of a display device 100 may include a display panel 110 and a display panel driver. The display panel driver may include a driving controller 120, a gate driver 130, a gamma reference voltage generator 140, a data driver 150, and an emission driver 160.

The display panel 110 may include a display area for displaying an image and a peripheral area disposed adjacent to the display area.

The display panel 110 may include gate lines GL, data lines DL, emission lines EML, and pixels PX electrically connected to the gate lines GL, the data lines DL, and the emission lines EML, respectively. The gate lines GL may extend in a first direction D1, the data lines DL may extend in a second direction D2 crossing the first direction D1, and the emission lines EML may extend in the first direction D1.

The driving controller 120 may receive input image data IMG and an input control signal CONT from an external device. In an embodiment, for example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, a fourth control signal CONT4, and a data signal DATA based on the input image data IMG and the input control signal CONT.

The driving controller 120 may generate the first control signal CONT1 for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The driving controller 120 may generate the fourth control signal CONT4 for controlling an operation of the emission driver 160 based on the input control signal CONT, and output the fourth control signal CONT4 to the emission driver 160.

The gate driver 130 may generate gate signals for driving the gate lines GL in response to the first control signal CONT1 received from the driving controller 120. The gate driver 130 may output the gate signals to the gate lines GL.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

In an embodiment, for example, the gamma reference voltage generator 140 may be disposed within (or integrated into) the driving controller 120 or may be disposed within the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

The emission driver 160 may generate emission signals for driving the emission lines EML in response to the fourth control signal CONT4 received from the driving controller 120. The emission driver 160 may output the emission signals to the emission lines EML.

In FIG. 1, for a convenience of illustration, an embodiment where the gate driver 130 is disposed on a first side of the display panel 110 and the emission driver 160 is disposed on a second side of the display panel 110 is shown. However, the invention is not limited thereto. In another embodiment, for example, both the gate driver 130 and the emission driver 160 may be disposed on the first side of the display panel 110. In another embodiment, for example, both the gate driver 130 and the emission driver 160 may be disposed on both opposing sides of the display panel 110. In an embodiment, for example, the gate driver 130 and the emission driver 160 may be formed integrally as a single unit, e.g., a chip or package.

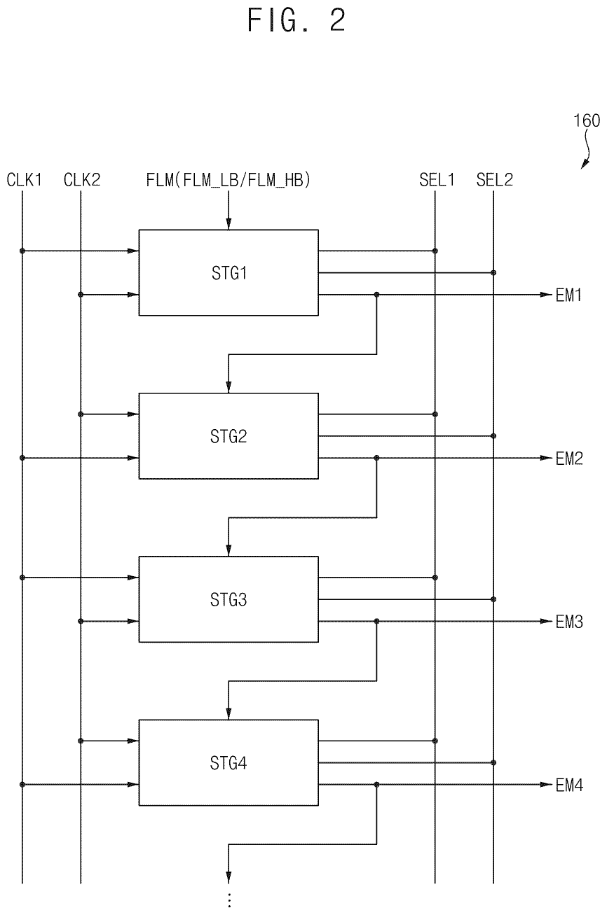

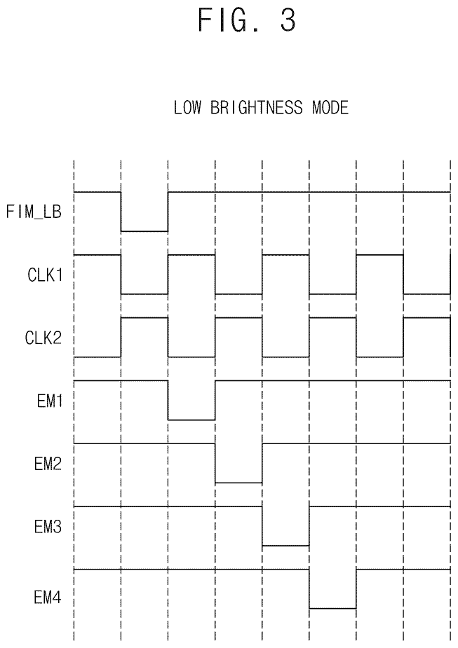

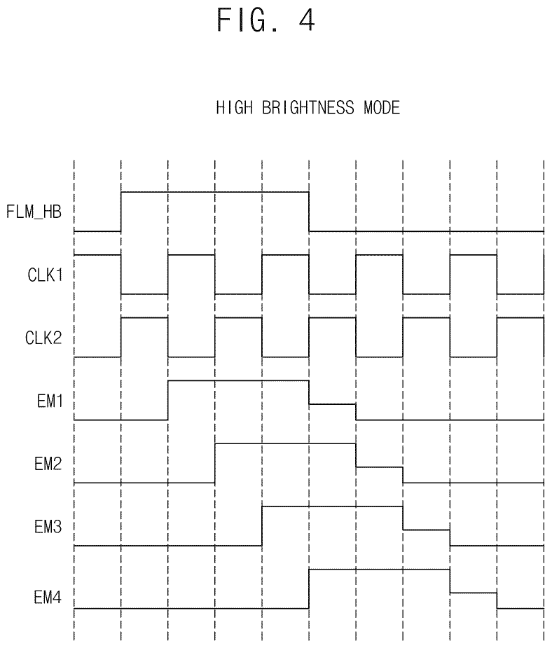

FIG. 2 is a block diagram showing an emission driver 160 of FIG. 1. FIG. 3 is a signal timing diagram showing an operation of an emission driver 160 of FIG. 2 in a low luminance mode. FIG. 4 is a signal timing diagram showing an operation of an emission driver 160 of FIG. 2 in a high luminance mode.

Referring to FIG. 2, an embodiment of an emission driver 160 may include a plurality of stages STG1, STG2, STG3, STG4, . . .. The stages STG1, STG2, STG3, STG4, . . . may receive an emission start signal FLM, a first clock signal CLK1, a second clock signal CLK2, a first selection signal SEL1, and a second selection signal SEL2. The stages STG1, STG2, STG3, STG4, . . . may sequentially generate and output emission signals EM1, EM2, EM3, EM4, . . . .

A first stage STG1 may receive the emission start signal FLM as an input signal, and subsequent stages STG2, STG3, STG4, . . . may receive previous emission signals EM1, EM2, EM3, EM4, . . . as the input signals.

In an embodiment, for example, the first stage STG1 may receive the emission start signal FLM as the input signal in response to the first clock signal CLK1. The first stage STG1 may generate and output a first emission signal EM1 in response to the second clock signal CLK2.

In an embodiment, for example, a second stage STG2 may receive the first emission signal EM1 as the input signal in response to the second clock signal CLK2. The second stage STG2 may generate and output a second emission signal EM2 in response to the first clock signal CLK1.

In an embodiment, for example, a third stage STG3 may receive the second emission signal EM2 as the input signal in response to the first clock signal CLK1. The third stage STG3 may generate and output a third emission signal EM3 in response to the second clock signal CLK2.

In an embodiment, for example, a fourth stage STG4 may receive the third emission signal EM3 as the input signal in response to the second clock signal CLK2. The fourth stage STG4 may generate and output a fourth emission signal EM4 in response to the first clock signal CLK1.

The emission driver 160 may operate in a low luminance mode or a high luminance mode. An emission signal EM1, EM2, EM3, EM4, . . . generated by the emission driver 160 may have a high level or a low level. In an embodiment, for example, when the emission signal EM1, EM2, EM3, EM4, . . . have an activation level (e.g., a low level), a light emitting element included in a pixel may emit a light such that a luminance may be expressed. In this case, a duration in which the emission signal EM1, EM2, EM3, EM4, . . . have the activation level may be a light emitting duration.

The low luminance mode may be a mode in which a maximum luminance expressed by the light emitting element is low, and the high luminance mode may be a mode in which the maximum luminance expressed by the light emitting element is high. Therefore, in the low luminance mode, a length in which the emission signal EM1, EM2, EM3, EM4, . . . has the activation level may be relatively short. On the other hand, in the high luminance mode, the length in which the emission signal EM1, EM2, EM3, EM4, . . . has the activation level may be relatively long.

In the low luminance mode and the high luminance mode, the emission start signal FLM, the first selection signal SEL1, and the second selection signal SEL2 received by the emission driver 160 may be different from each other. In the low luminance mode, the first selection signal SEL1 may have an activation level and the second selection signal SEL2 may have a deactivation level. In the high luminance mode, the first selection signal SEL1 may have the deactivation level and the second selection signal SEL2 may have the activation level. Here, the activation level may be a level of a signal provided to a gate electrode of a transistor to turn on the transistor, and the deactivation level may be a level of the signal provided to the gate electrode of the transistor to turn on the transistor. In addition, the emission start signal FLM may be a low luminance emission start signal FLM_LB or a high luminance emission start signal FLM_HB. In the low luminance mode, the emission start signal FLM may be the low luminance emission start signal FLM_LB. In the high luminance mode, the emission start signal FLM may be the high luminance emission start signal FLM_HB.

In an embodiment, as shown in FIGS. 3 and 4, a length of a low level of the low luminance emission start signal FLM_LB may be less than a length of a high level of the high luminance emission start signal FLM_HB. Accordingly, a length of a low level of the emission signal EM1, EM2, EM3, EM4, . . . in the low luminance mode may be less than a length of a low level of the emission signal EM1, EM2, EM3, EM4, . . . in the high luminance mode. In an embodiment, for example, the length of the low level of the emission signal EM1, EM2, EM3, EM4, . . . may be equal to or less than 1 horizontal time. The length of the low level of the emission signal EM1, EM2, EM3, EM4, . . . in the high luminance mode may be equal to or greater than 2 horizontal times.

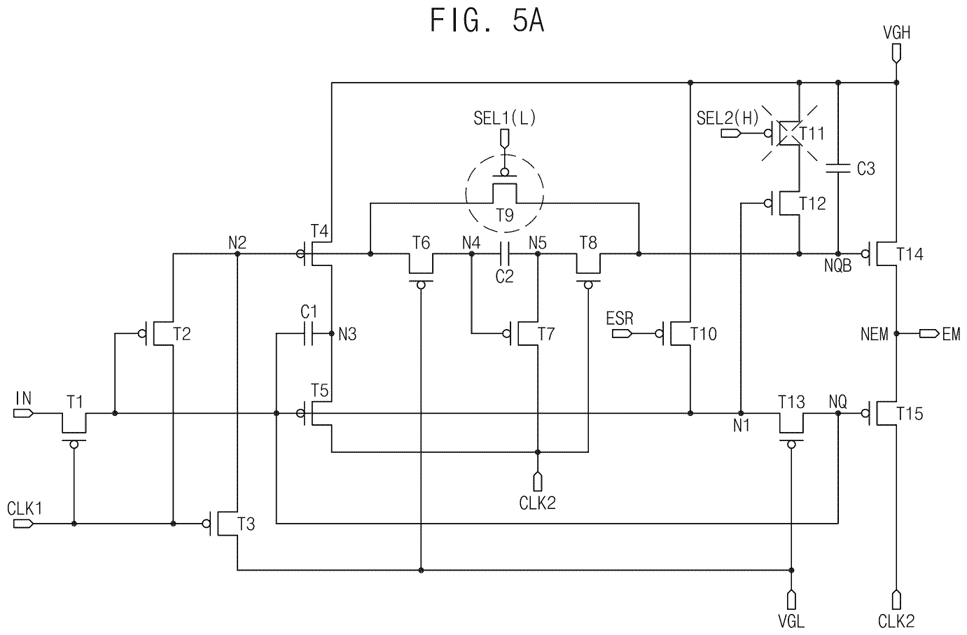

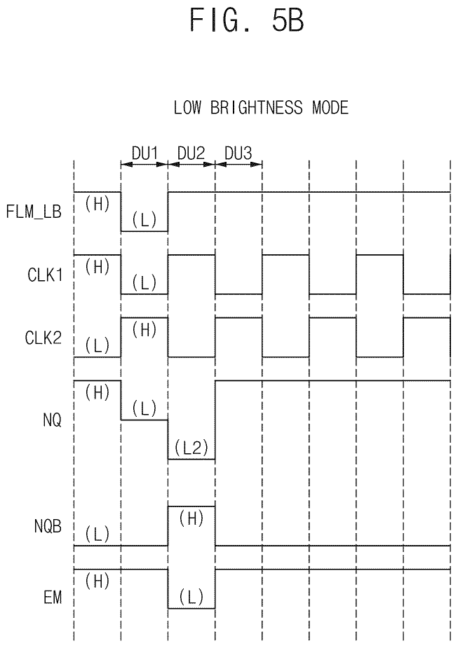

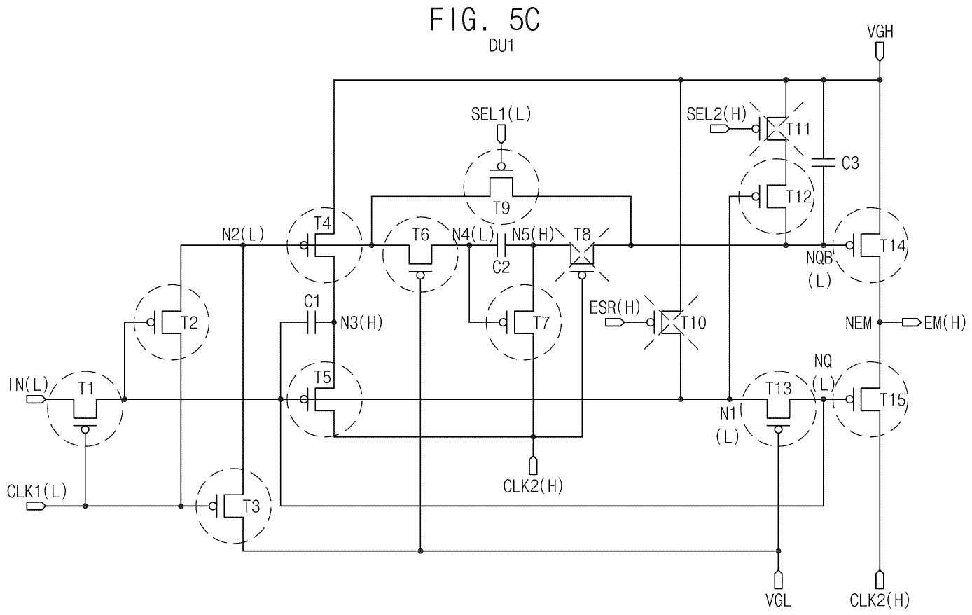

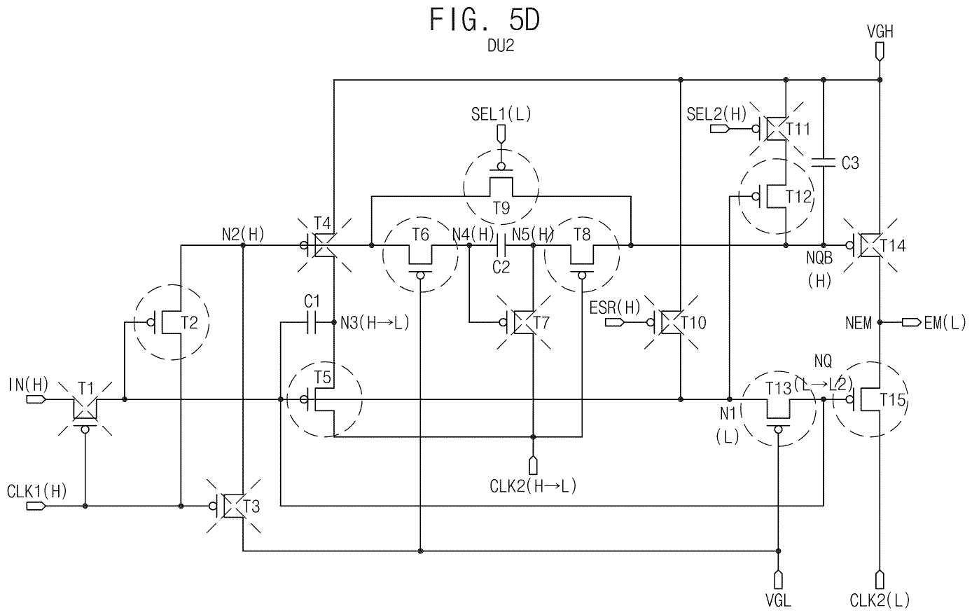

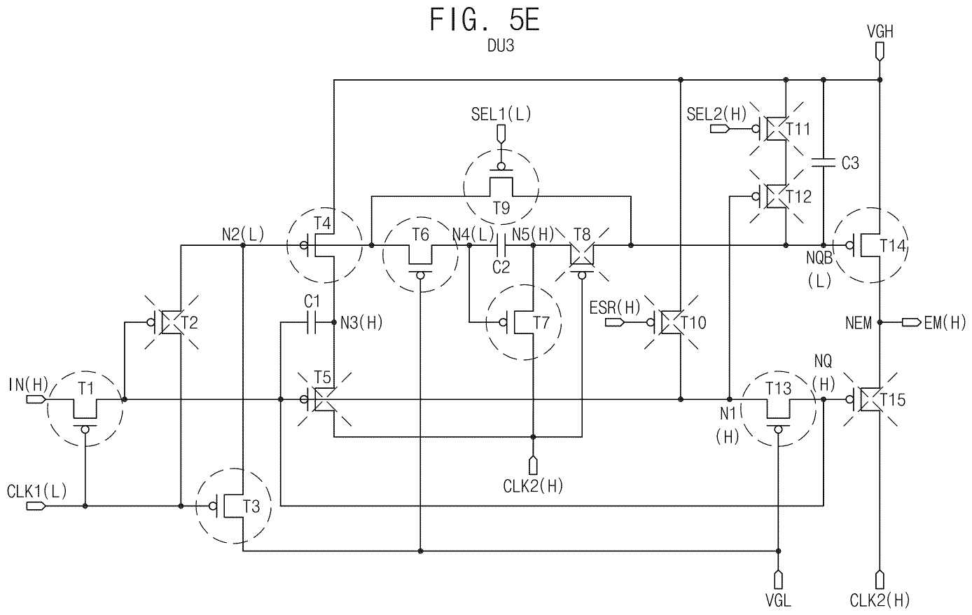

FIG. 5A is a circuit diagram showing an example of a stage STG_LB of FIG. 2 in a low luminance mode. FIG. 5B is a signal timing diagram showing an input signal IN, a first clock signal CLK1, a second clock signal CLK2, a voltage of a control node NQ, a voltage of an inversion control node NQB, and an emission signal EM of FIG. 5A. FIG. 5C is a circuit diagram showing an operation of a stage STG_LB of FIG. 5A in a first duration DU1 of FIG. 5B. FIG. 5D is a circuit diagram showing an operation of a stage STG_LB of FIG. 5A in a second duration DU2 of FIG. 5B. FIG. 5E is a circuit diagram showing an operation of a stage STG_LB of FIG. 5A in a third duration DU3 of FIG. 5B.

Referring to FIG. 5A, the emission driver 160 according to embodiments of the invention may include a plurality of stages. Each of the stages may receive an input signal IN, a first clock signal CLK1, a second clock signal CLK2, a first selection signal SEL1, and a second selection signal SEL2. Each of the stages may generate and output emission signals EM. Each of the stages may include first to fifteenth transistors T1 to T15 and first to third capacitors C1 to C3. A gate electrode of the ninth transistor T9 may receive the first selection signal SEL1, and a gate electrode of the eleventh transistor T11 may receive the second selection signal SEL2.

When each of the stages operates in a low luminance mode, the first selection signal SEL1 may have an activation level, and the second selection signal SEL2 may have a deactivation level. In an embodiment, the first to fifteenth transistors T1 to T15 may be p-channel metal-oxide-semiconductor (PMOS) transistors. In such an embodiment, the activation level of each of the ninth transistor T9 and the eleventh transistor T11 may be a low level L, and the deactivation level of each of the ninth transistor T9 and the eleventh transistor T11 may be a high level H. In another embodiment, the first to eighth transistors T1 to T8, the tenth transistor T10, and the twelfth to fifteenth transistors T12 to T15 may be PMOS transistors, and the ninth transistor T9 and the eleventh transistor T11 may be n-channel metal-oxide-semiconductor (NMOS) transistors. In such an embodiment, the activation level of each of the ninth transistor T9 and the eleventh transistor T11 may be the high level H, and the deactivation level of each of the ninth transistor T9 and the eleventh transistor T11 may be the low level L. However, for convenience of explanation, explanation will be based on the case where the ninth transistor T9 and the eleventh transistor T11 are the PMOS transistors.

The first transistor T1 may include a gate electrode that receives (or connected to receive) the first clock signal CLK1, a first electrode that receives the input signal IN, and a second electrode connected to a first node N1. The input signal IN may be an emission start signal or a previous emission signal. Since each stage is driven in a low luminance mode, the emission start signal may be a low luminance emission start signal. The first transistor T1 may provide the input signal IN to the first node N1 in response to the first clock signal CLK1.

The second transistor T2 may include a gate electrode connected to the first node N1, a first electrode that receives the first clock signal CLK1, and a second electrode connected to a second node N2. The second transistor T2 may provide the first clock signal CLK1 to the second node N2 in response to a voltage of the first node N1.

The third transistor T3 may include a gate electrode that receives the first clock signal CLK1, a first electrode that receives a low gate voltage VGL, and a second electrode connected to the second node N2. The third transistor T3 may provide the low gate voltage VGL to the second node N2 in response to the first clock signal CLK1.

The fourth transistor T4 may include a gate electrode connected to the second node N2, a first electrode that receives a high gate voltage VGH, and a second electrode connected to a third node N3. The fourth transistor T4 may provide the high gate voltage VGH to the third node N3 in response to a voltage of the second node N2.

The fifth transistor T5 may include a gate electrode connected to the first node N1, a first electrode that receives the second clock signal CLK2, and a second electrode connected to the third node N3. The fifth transistor T5 may provide the second clock signal CLK2 to the third node N3 in response to the voltage of the first node N1.

The sixth transistor T6 may include a gate electrode that receives the low gate voltage VGL, a first electrode connected to the second node N2, and a second electrode connected to a fourth node N4. The sixth transistor T6 may always be turned on in response to the low gate voltage VGL. The sixth transistor T6 may control the voltage of the second node N2 and a voltage of the fourth node N4 based on the low gate voltage VGL. Specifically, the sixth transistor T6 may provide the voltage of the second node N2 to the fourth node N4. However, when the voltage of the fourth node N4 is less than a specific level, the sixth transistor T6 may not provide the voltage of the fourth node N4 to the second node N2.

The seventh transistor T7 may include a gate electrode connected to the fourth node N4, a first electrode that receives the second clock signal CLK2, and a second electrode connected to a fifth node N5. The seventh transistor T7 may provide the second clock signal CLK2 to the fifth node N5 in response to the voltage of the fourth node N4.

The eighth transistor T8 may include a gate electrode that receives the second clock signal CLK2, a first electrode connected to the fifth node N5, and a second electrode connected to an inversion control node NQB. The eighth transistor T8 may provide a voltage of the fifth node N5 to the inversion control node NQB in response to the second clock signal CLK2.

The ninth transistor T9 may include a gate electrode that receives the first selection signal SEL1, a first electrode, and a second electrode connected to the inversion control node NQB. Since the first selection signal SEL1 has the low level L in the low luminance mode, the ninth transistor T9 may always be turned on. In an embodiment, as shown in FIG. 5A, the first electrode of the ninth transistor may be connected to the second node N2. In such an embodiment, the ninth transistor T9 may provide the voltage of the second node N2 to the inversion control node NQB. In another embodiment, the first electrode of the ninth transistor may be connected to the fourth node N4. may be. In such an embodiment, the ninth transistor T9 may provide the voltage of the fourth node N4 to the inversion control node NQB. In an embodiment, the ninth transistor T9 may include (or be defined by a structure including) two sub-transistors (e.g., a first ninth transistor (not shown) and a second ninth transistor (not shown)) which are connected to each other in series and gate electrodes of which are connected to each other.

The tenth transistor T10 may include a gate electrode that receives a reset signal ESR, a first electrode that receives the high gate voltage VGH, and a second electrode connected to the first node N1. The reset signal ESR may be a signal that initializes the voltage of the first node N1 before the emission driver 160 is driven. When the reset signal ESR has the low level L, the tenth transistor may be turned on to provide the high gate voltage VGH to the first node N1. Therefore, when the emission driver 160 is driven, the reset signal ESR may have a high level H, and the tenth transistor T10 may maintain a turn-off state.

The eleventh transistor T11 may include a gate electrode that receives the second selection signal SEL2, a first electrode that receives the high gate voltage VGH, and a second electrode. Since the first selection signal SEL1 has the high level H in the low luminance mode, the eleventh transistor T11 may always be turned off. In an embodiment, the eleventh transistor T11 may include (or be defined by a structure including) two sub-transistors (e.g., a first eleventh transistor (not shown) and a second eleventh transistor (not shown)) which are connected to each other in series and gate electrodes of which are connected to each other.

The twelfth transistor T12 may include a gate electrode connected to the first node N1, a first electrode connected to the second electrode of the eleventh transistor T11, and a second electrode connected to the inversion control node NQB.

In another embodiment, the positions of the eleventh transistor T11 and the twelfth transistor T12 may be opposite to (or reversed in order in) those in FIG. 5A. In such an embodiment, the twelfth transistor T12 may include a gate electrode connected to the first node N1, a first electrode that receives the high gate voltage VGH, and a second electrode, and the eleventh transistor T11 may include a gate electrode that receives the second selection signal SEL2, a first electrode connected to the second electrode of the twelfth transistor T12, and a second electrode connected to the inversion control node NQB. However, for convenience of description, a connection relationship between the eleventh transistor T11 and the twelfth transistor T12 will be described based on FIG. 5A.

The thirteenth transistor T13 may include a gate electrode that receives the low gate voltage VGL, a first electrode connected to the first node N1, and a second electrode connected to a control node NQ. The thirteenth transistor T13 may always be turned on in response to the low gate voltage VGL. The thirteenth transistor T13 may control the voltage of the first node N1 and a voltage of the control node NQ based on the low gate voltage VGL. In such an embodiment, the thirteenth transistor T13 may provide the voltage of the first node N1 to the control node NQ. However, when the voltage of the control node NQ is less than a specific level, the thirteenth transistor T13 may not provide the voltage of the control node NQ to the first node N1.

The fourteenth transistor T14 may include a gate electrode connected to the inversion control node NQB, a first electrode that receives the high gate voltage VGH, and a second electrode connected to an emission output node NEM from which an emission signal EM is output. The fourteenth transistor T14 may provide the high gate voltage VGH as the emission signal EM to the emission output node NEM in response to a voltage of the inversion control node NQB.

The fifteenth transistor T15 may include a gate electrode connected to the control node NQ, a first electrode, and a second electrode connected to the emission output node NEM. In the low luminance mode, the first electrode of the fifteenth transistor T15 may receive the second clock signal CLK. In this case, the fifteenth transistor T15 may provide the second clock signal CLK2 as the emission signal EM to the emission output node NEM in response to the voltage of the control node NQ.

The first capacitor C1 may include a first electrode connected to the first node N1 and a second electrode connected to the third node N3. The first capacitor C1 may store a voltage difference between the two electrodes.

The second capacitor C2 may include a first electrode connected to the fourth node N4 and a second electrode connected to the fifth node N5. The second capacitor C2 may store a voltage difference between the two electrodes.

The third capacitor C3 may include a first electrode that receives the high gate voltage VGH and a second electrode connected to the inversion control node NQB. The third capacitor C3 may store a voltage difference between the two electrodes.

Referring to FIG. 5B and FIG. 5C, in a first duration DU1 of the low luminance mode, the input signal IN may have the low level L, the first clock signal CLK1 may have the low level L, and the second clock signal CLK2 may have the high level H.

In the first duration DU1 of the low luminance mode, the first transistor T1 may be turned on in response to the first clock signal CLK1 having the low level L to provide the input signal IN having the low level L to the first node N1. Therefore, the voltage of the first node N1 may have the low level L.

In the first duration DU1 of the low luminance mode, the second transistor T2 may be turned on in response to the voltage of the first node N1 having the low level L to provide the first clock signal CLK1 having the low level L to the second node N2. Therefore, the voltage of the second node N2 may have the low level L.

In the first duration DU1 of the low luminance mode, the third transistor T3 may be turned on in response to the first clock signal CLK1 having the low level L to provide the low gate voltage VGL to the second node N2. Therefore, the voltage of the second node N2 may have the low level L.

In the first duration DU1 of the low luminance mode, the fourth transistor T4 may be turned on in response to the voltage of the second node N2 having the low level L to provide the high gate voltage VGH to the third node N3. Therefore, the voltage of the third node N3 may have the high level H.

In the first duration DU1 of the low luminance mode, the fifth transistor T5 may be turned on in response to the voltage of the first node N1 having the low level L to provide the second clock signal CLK2 having the high level H to the third node N3. Therefore, the voltage of the third node N3 may have the high level H.

In the first duration DU1 of the low luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the first duration DU1 of the low luminance mode, the seventh transistor T7 may be turned on in response to the voltage of the fourth node N4 having the low level L to provide the second clock signal CLK2 having the high level H to the fifth node N5. Therefore, the voltage of the fifth node N5 may have the high level H.

The eighth transistor T8 may be turned off in response to the second clock signal CLK2 having the high level H.

In the first duration DU1 of the low luminance mode, the ninth transistor T9 may be turned on in response to the first selection signal SEL1 having the low level L to provide the voltage of the second node N2 having the low level L to the inversion control node NQB. Therefore, the voltage of the inversion control node NQB may have the low level L.

In the first duration DU1 of the low luminance mode, the tenth transistor T10 may be turned off in response to the reset signal ESR having the high level H.

In the first duration DU1 of the low luminance mode, the eleventh transistor T11 may be turned off in response to the second selection signal SEL2 having the high level H.

In the first duration DU1 of the low luminance mode, the twelfth transistor T12 may be turned on in response to the voltage of the first node N1 having the low level L.

In the first duration DU1 of the low luminance mode, the thirteenth transistor T13 may be turned on in response to the low gate voltage VGL to provide the voltage of the first node N1 having the low level L to the control node NQ. Therefore, the voltage of the control node NQ may have the low level L.

In the first duration DU1 of the low luminance mode, the fourteenth transistor T14 may be turned on in response to the voltage of the inversion control node NQB having the low level L to provide the high gate voltage VGH to the emission output node NEM. Therefore, the emission signal EM may have the high level H.

In the first duration DU1 of the low luminance mode, the fifteenth transistor T15 may be turned on in response to the voltage of the control node NQ having the low level L to provide the second clock signal CLK2 having the high level H to the emission output node NEM. Therefore, the emission signal EM may have the high level H.

Since the voltage of the control node NQ has the low level L and the voltage of the third node N3 has the high level H, the first capacitor C1 may store a difference between the high level H and the low level L.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the low level L, the third capacitor C3 may store the difference between the high level H and the low level L.

Referring to FIGS. 5B and 5D, in a second duration DU2 of the low luminance mode, the input signal IN may have the high level H, the first clock signal CLK1 may have the high level H, and the second clock signal CLK2 may have the low level L.

In the second duration DU2 of the low luminance mode, the first transistor T1 may be turned off in response to the first clock signal CLK1 having the high level H. Therefore, the voltage of the first node N1 may maintain the low level L.

In the second duration DU2 of the low luminance mode, the second transistor T2 may be turned on in response to the voltage of the first node N1 having the low level L to provide the first clock signal CLK1 having the high level H to the second node N2. Therefore, the voltage of the second node N2 may have the high level H.

In the second duration DU2 of the low luminance mode, the third transistor T3 may be turned off in response to the first clock signal CLK1 having the high level H.

In the second duration DU2 of the low luminance mode, the fourth transistor T4 may be turned off in response to the voltage of the second node N2 having the high level H.

In the second duration DU2 of the low luminance mode, the fifth transistor T5 may be turned on in response to the voltage of the first node N1 having the low level L to provide the second clock signal CLK2 having the high level H to the third node N3. Therefore, the voltage of the third node N3 may have the low level L.

In the second duration DU2 of the low luminance mode, when the second clock signal CLK2 changes from the high level H to the low level L and the voltage of the third node N3 changes from the high level H to the low level L, the voltage of the control node NQ may be bootstrapped by the first capacitor C1. Therefore, the voltage of the control node NQ may be changed from the low level L to a second low level L2 less than the low level L.

In the second duration DU2 of the low luminance mode, the sixth transistor T6 may be turned on in response to the low gate voltage VGL to provide the voltage of the second node N2 having the high level H to the fourth node N4. Therefore, the voltage of the fourth node N4 may have the high level H.

In the second duration DU2 of the low luminance mode, the seventh transistor T7 may be turned off in response to the voltage of the fourth node N4 having the high level H.

In the second duration DU2 of the low luminance mode, the ninth transistor T9 may be turned on in response to the first selection signal SEL1 having the low level L to provide the voltage of the second node N2 having the high level H to the inversion control node NQB. Therefore, the voltage of the inversion control node NQB may be the high level H.

In the second duration DU2 of the low luminance mode, the eighth transistor T8 may be turned on in response to the second clock signal CLK2 having the low level L to provide the voltage of the inversion control node NQB having the high level H to the fifth node N5. Therefore, the voltage of the fifth node N5 may have the high level H.

In the second duration DU2 of the low luminance mode, the tenth transistor T10 may be turned off in response to the reset signal ESR having the high level H.

In the second duration DU2 of the low luminance mode, the eleventh transistor T11 may be turned off in response to the second selection signal SEL2 having the high level H.

In the second duration DU2 of the low luminance mode, the twelfth transistor T12 may be turned on in response to the voltage of the first node N1 having the low level L.

When the voltage of the control node NQ has the second low level L2 less than the low level L, the thirteenth transistor T13 may not provide the voltage of the control node NQ having the second low level L2 to the first node N1. Therefore, the voltage of the first node N1 may maintain the low level L, and the voltage of the control node NQ may maintain the second low level L2.

In the second duration DU2 of the low luminance mode, the fourteenth transistor T14 may be turned off in response to the voltage of the inversion control node NQB having the high level H.

In the second duration DU2 of the low luminance mode, the fifteenth transistor T15 may be sufficiently turned on in response to the voltage of the control node NQ having the second low level L2 to provide the second clock signal CLK2 having the low level L to the emission output node NEM. Therefore, the emission signal EM may have the low level L.

Since the voltage of the control node NQ has the second low level L2 and the voltage of the third node N3 has the low level L, the first capacitor C1 may store the difference between the low level L and the second low level L2. In an embodiment, for example, the difference between the low level L and the second low level L2 may be equal to the difference between the high level H and the low level L.

Since the voltage of the fourth node N4 has the high level H and the voltage of the fifth node N5 has the high level H, the second capacitor C2 may not store the voltage difference.

Since the first electrode of the third capacitor C3 has the high level H and the voltage of the inversion control node NQB has the high level H, the third capacitor C3 may not store the voltage difference.

Referring to FIGS. 5B and 5E, in a third duration DU3 of the low luminance mode, the input signal IN may have the high level H, the first clock signal CLK1 may have the low level L, and the second clock signal CLK2 may have the high level H.

In the third duration DU3 of the low luminance mode, the first transistor T1 may be turned on in response to the first clock signal CLK1 having the low level L to provide the input signal IN having the low level L to the first node N1. Therefore, the voltage of the first node N1 may have the high level H.

In the third duration DU3 of the low luminance mode, the second transistor T2 may be turned off in response to the voltage of the first node N1 having the high level H.

In the third duration DU3 of the low luminance mode, the third transistor T3 may be turned on in response to the first clock signal CLK1 having the low level L to provide the low gate voltage VGL to the second node N2. Therefore, the voltage of the second node N2 may have the low level L.

The fourth transistor T4 may be turned on in response to the voltage of the second node N2 having the low level L to provide the high gate voltage VGH to the third node N3. Therefore, the voltage of the third node N3 may have the high level H.

In the third duration DU3 of the low luminance mode, the fifth transistor T5 may be turned off in response to the voltage of the first node N1 having the high level H.

In the third duration DU3 of the low luminance mode, the sixth transistor T6 may be turned on in response to the low gate voltage VGL to provide the voltage of the second node N2 having the low level L to the fourth node N4. Therefore, the voltage of the fourth node N4 may have the low level L.

The seventh transistor T7 may be turned on in response to the voltage of the fourth node N4 having the low level L to provide the second clock signal CLK2 having the high level H to the fifth node N5. Therefore, the voltage of the fifth node N5 may have the high level H.

In the third duration DU3 of the low luminance mode, the eighth transistor T8 may be turned off in response to the second clock signal CLK2 having the high level H.

In the third duration DU3 of the low luminance mode, the ninth transistor T9 may be turned on in response to the first selection signal SEL1 having the low level L to provide the voltage of the second node N2 having the low level L to the inversion control node NQB. Therefore, the voltage of the inversion control node NQB may have the low level L.

In the third duration DU3 of the low luminance mode, the tenth transistor T10 may be turned off in response to the reset signal ESR having the high level H.

In the third duration DU3 of the low luminance mode, the eleventh transistor T11 may be turned off in response to the second selection signal SEL2 having the high level H.

In the third duration DU3 of the low luminance mode, the twelfth transistor T12 may be turned on in response to the voltage of the first node N1 having the low level L.

The thirteenth transistor T13 may be turned on in response to the low gate voltage VGL to provide the voltage of the first node N1 having the low level L to the control node NQ. Therefore, the voltage of the control node NQ may have the low level L.

In the third duration DU3 of the low luminance mode, the fourteenth transistor T14 may be turned on in response to the voltage of the inversion control node NQB having the low level L to provide the high gate voltage VGH to the emission output node NEM. Therefore, the emission signal EM may have the high level H.

In the third duration DU3 of the low luminance mode, the fifteenth transistor T15 may be turned on in response to the voltage of the control node NQ having the low level L to provide the second clock signal CLK2 having the high level H to the emission output node NEM. Therefore, the emission signal EM may have the high level H.

Since the voltage of the control node NQ has the low level L and the voltage of the third node N3 has the high level H, the first capacitor C1 may store the difference between the high level H and the low level L.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the low level L, the third capacitor C3 may store the difference between the high level H and the low level L.

In an embodiment as described above, in the low luminance mode, the length of the low level L of the emission signal EM may be equal to or less than 1 horizontal time. That is, the emission driver 160 may finely adjust a pulse width of the emission signal EM provided to a pixel including a light emitting element driven by an Impulse PAM method, such that a maximum luminance expressed by the light emitting element may be finely adjusted.

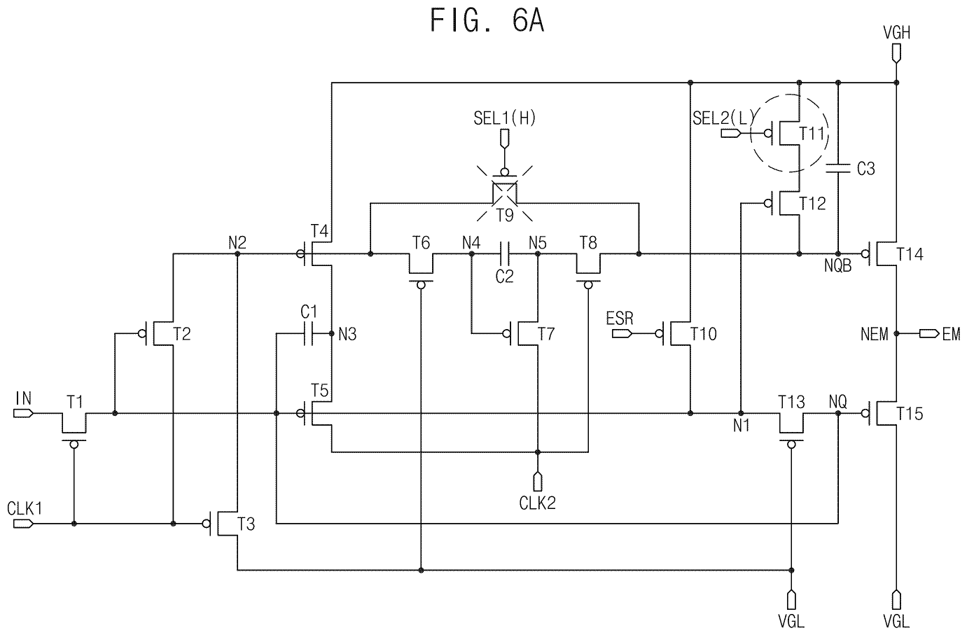

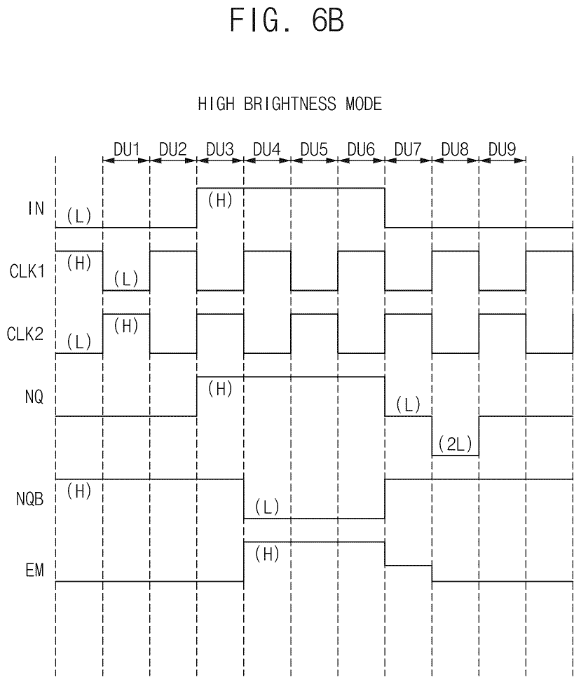

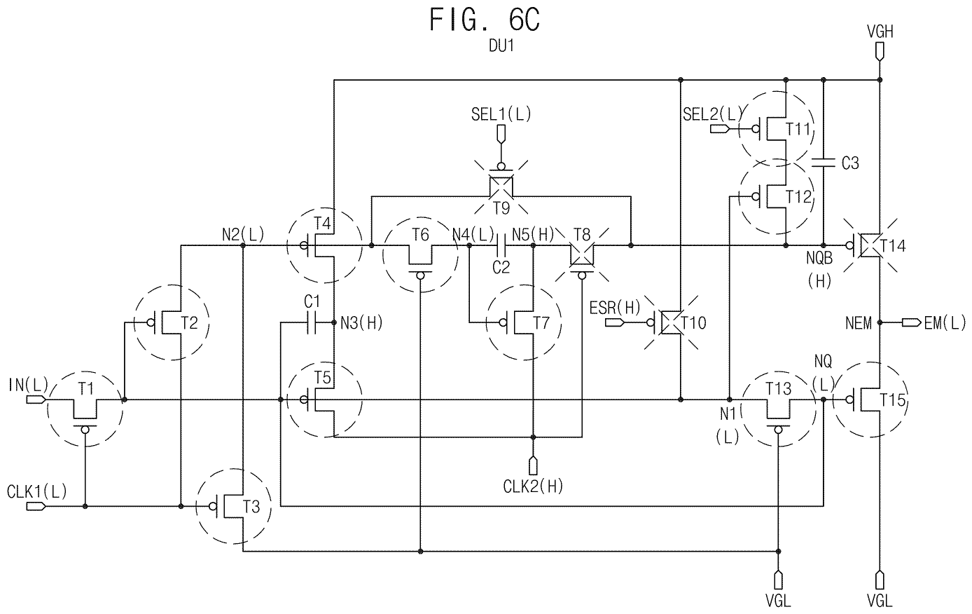

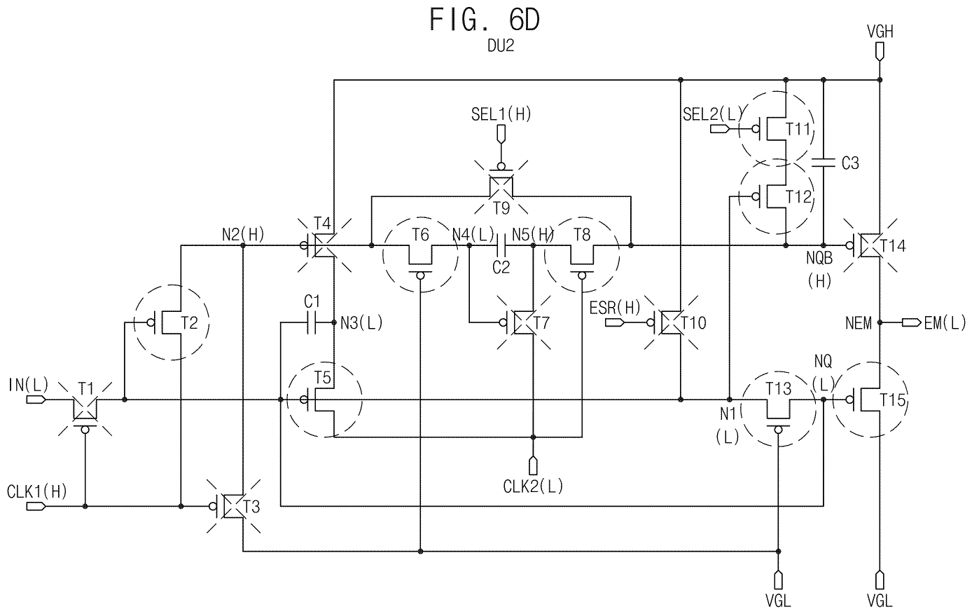

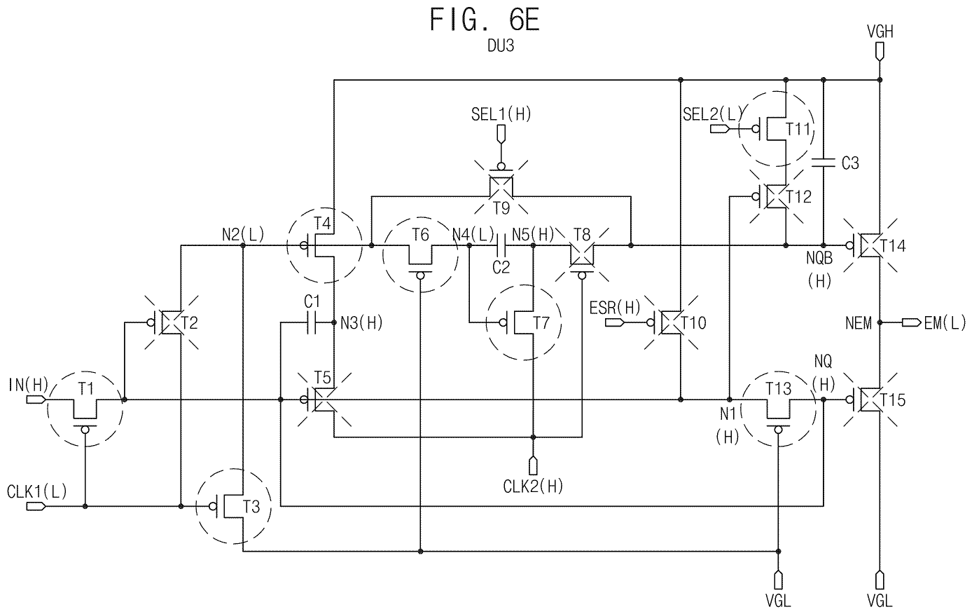

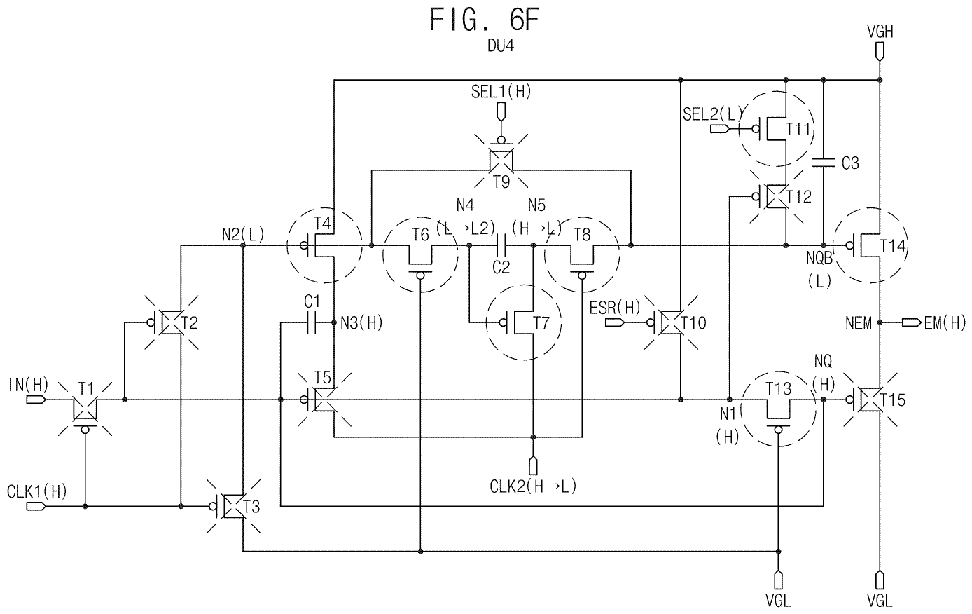

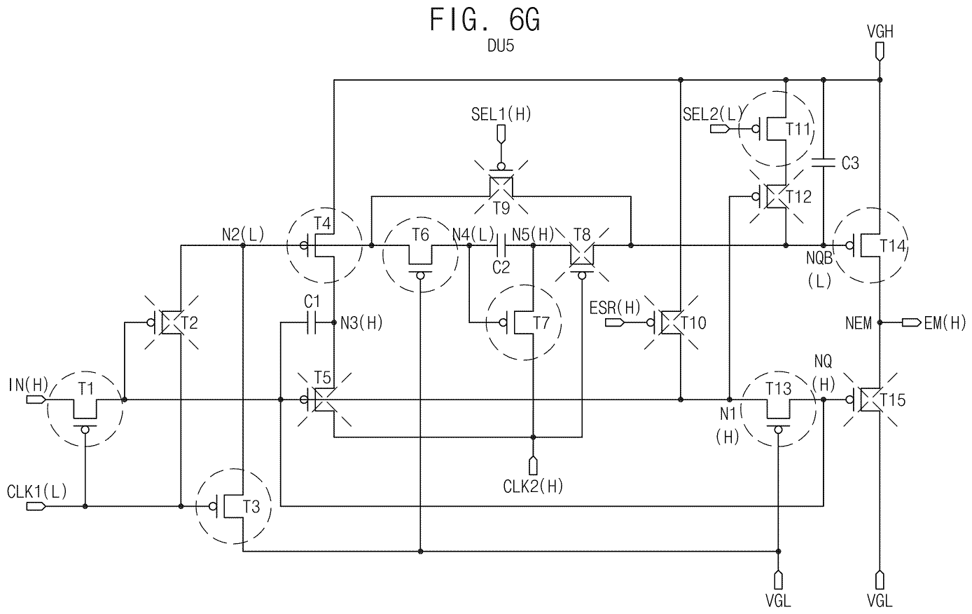

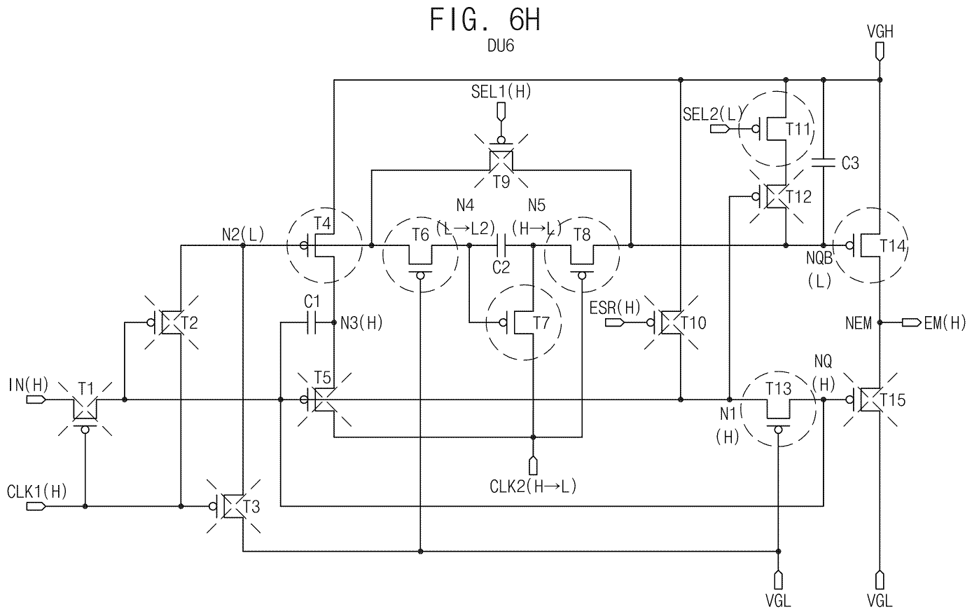

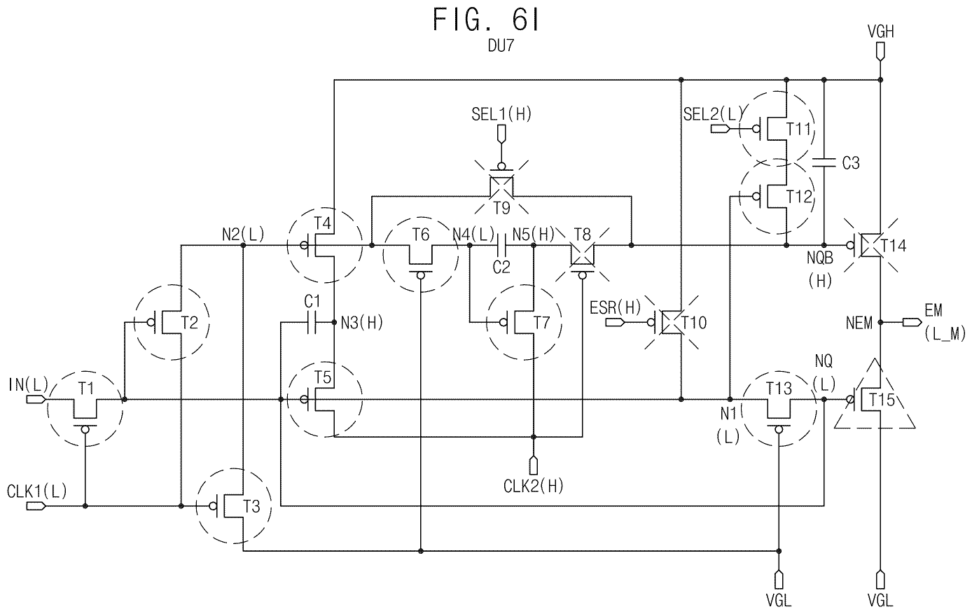

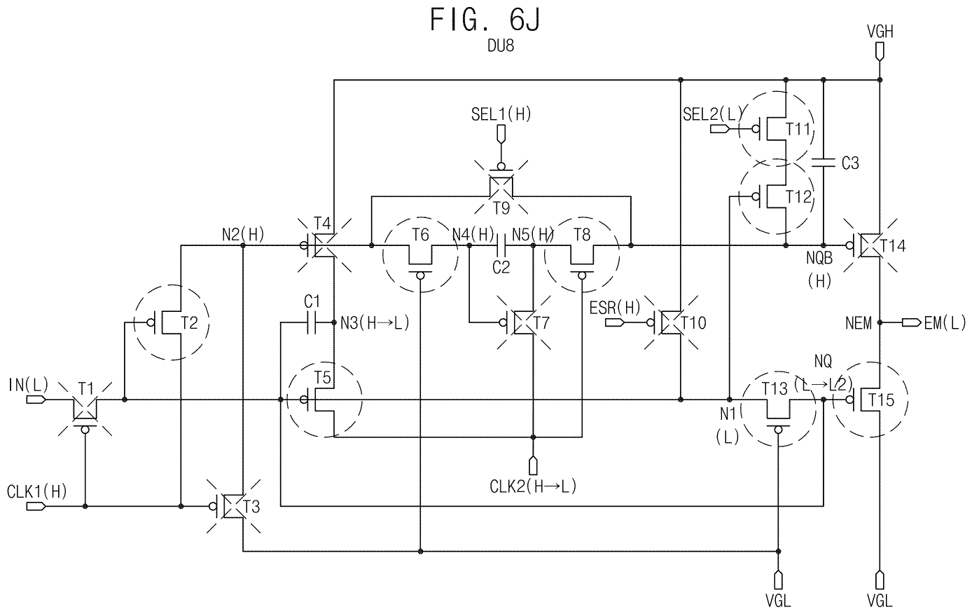

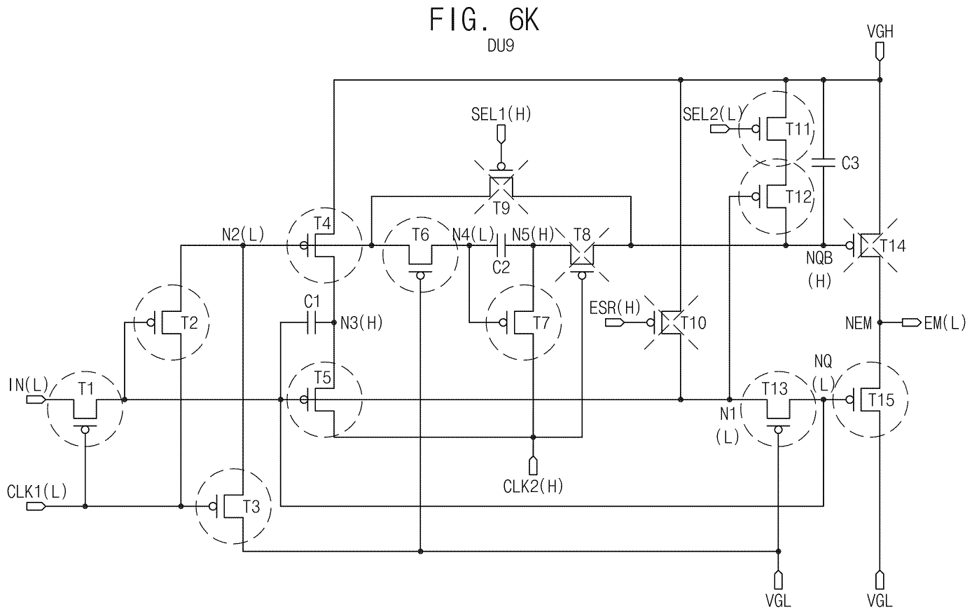

FIG. 6A is a circuit diagram showing an example of a stage of FIG. 2 in a high luminance mode. FIG. 6B is a signal timing diagram showing an input signal IN, a first clock signal CLK1, a second clock signal CLK2, a voltage of a control node NQ, a voltage of an inversion control node NQB, and an emission signal EM of FIG. 6A. FIG. 6C is a circuit diagram showing an operation of a stage of FIG. 6A in a first duration DU1 of FIG. 6B. FIG. 6D is a circuit diagram showing an operation of a stage of FIG. 6A in a second duration DU2 of FIG. 6B. FIG. 6E is a circuit diagram showing an operation of a stage of FIG. 6A in a third duration DU3 of FIG. 6B. FIG. 6F is a circuit diagram showing an operation of a stage of FIG. 6A in a fourth duration DU4 of FIG. 6B. FIG. 6G is a circuit diagram showing an operation of a stage of FIG. 6A in a fifth duration DU5 of FIG. 6B. FIG. 6H is a circuit diagram showing an operation of a stage of FIG. 6A in a sixth duration DU6 of FIG. 6B. FIG. 6I is a circuit diagram showing an operation of a stage of FIG. 6A in a seventh duration DU7 of FIG. 6B. FIG. 6J is a circuit diagram showing an operation of a stage of FIG. 6A in an eighth duration DU8 of FIG. 6B. FIG. 6K is a circuit diagram showing an operation of a stage of FIG. 6A in a ninth duration DU9 of FIG. 6B.

Referring to FIG. 6A, an emission driver 160 according to embodiments of the invention may include a plurality of stages. Each of the stages may receive an input signal IN, a first clock signal CLK1, a second clock signal CLK2, a first selection signal SEL1, and a second selection signal SEL2. Each of the stages may generate and output emission signals EM. Each of the stages may include first to fifteenth transistors T1 to T15 and first to third capacitors C1 to C3. A gate electrode of the ninth transistor T9 may receive the first selection signal SEL1, and a gate electrode of the eleventh transistor T11 may receive the second selection signal SEL2.

When each of the stages operates in a high luminance mode, the first selection signal SEL1 may have a deactivated level and the second selection signal SEL2 may have an activated level. In an embodiment, the first to fifteenth transistors T1 to T15 may be PMOS transistors. In such an embodiment, an activation level of each of the ninth transistor T9 and the eleventh transistor T11 may be a low level L, and a deactivation level of each of the ninth transistor T9 and the eleventh transistor T11 may be a high level H. In another embodiment, the first to eighth transistors T1 to T8, the tenth transistor T10, and the twelfth to fifteenth transistors T12 to T15 may be PMOS transistors, and the ninth transistor T9 and the eleventh transistor T11 may be NMOS transistors. In this case, an activation level of each of the ninth transistor T9 and the eleventh transistor T11 may be the high level H, and a deactivation level of each of the ninth transistor T9 and the eleventh transistor T11 may be the low level L. However, for convenience of explanation, explanation will be based on the case where the ninth transistor T9 and the eleventh transistor T11 are PMOS transistors.

The stage of FIG. 6A is similar in a configuration and an operation to the stage of FIG. 5A except for the input signal IN and the fifteenth transistor T15. An emission start signal of the input signal IN of FIG. 5A is a low luminance emission start signal. On the other hand, the emission start signal of the input signal IN of FIG. 6A is a high luminance emission start signal. In addition, a first electrode of the fifteenth transistor T15 of FIG. 5A receives the second clock signal CLK2. On the other hand, the first electrode of the fifteenth transistor T15 of FIG. 6A receives the low gate voltage VGL. For convenience of description, any repetitive detailed description of a configuration and a connection relationship of the first to fifteenth transistors T1 to T15 and the first to third capacitors C1 to C3 will be omitted.

Referring to FIGS. 6B and 6C, in a first duration DU1 of the high luminance mode, the input signal IN may have the low level L, the first clock signal CLK1 may have the low level L, and the second clock signal CLK2 may have the high level H.

In the first duration DU1 of the high luminance mode, the first transistor T1 may be turned on in response to the first clock signal CLK1 having the low level L to provide the input signal IN having the low level L to the first node N1. Therefore, the voltage of the first node N1 may have the low level L.

In the first duration DU1 of the high luminance mode, the second transistor T2 may be turned on in response to the voltage of the first node N1 having the low level L to provide the first clock signal CLK1 having the low level L to the second node N2. Therefore, the voltage of the second node N2 may have the low level L.

In the first duration DU1 of the high luminance mode, the third transistor T3 may be turned on in response to the first clock signal CLK1 having the low level L to provide the low gate voltage VGL to the second node N2. Therefore, the voltage of the second node N2 may have the low level L.

In the first duration DU1 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the first duration DU1 of the high luminance mode, the fifth transistor T5 may be turned on in response to the voltage of the first node N1 having the low level L to provide the second clock signal CLK2 having the high level H to the third node N3. Therefore, the voltage of the third node N3 may have the high level H.

In the first duration DU1 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the first duration DU1 of the high luminance mode, the seventh transistor T7 may be turned on in response to the voltage of the fourth node N4 having the low level L and may provide the second clock signal CLK2 having the high level H to the fifth node N5. Therefore, the voltage of the fifth node N5 may have the high level H.

In the first duration DU1 of the high luminance mode, the eighth transistor T8 may be turned off in response to the second clock signal CLK2 having the high level H.

In the first duration DU1 of the high luminance mode, the ninth transistor T9 may be turned off in response to the first selection signal SEL1 having the high level H.

In the first duration DU1 of the high luminance mode, the tenth transistor T10 may be turned off in response to the reset signal ESR having the high level H.

In the first duration DU1 of the high luminance mode, the eleventh transistor T11 may be turned on in response to the second selection signal SEL2 having the low level L to provide the high gate voltage VGH to the first electrode of the twelfth transistor T12.

In the first duration DU1 of the high luminance mode, the twelfth transistor T12 may be turned on in response to the voltage of the first node N1 having the low level L to provide the voltage of the first electrode of the twelfth transistor T12 having the high level H to the inversion control node NQB. Therefore, the voltage of the inversion control node NQB may have the high level H.

In the first duration DU1 of the high luminance mode, the thirteenth transistor T13 may be turned on in response to the low gate voltage VGL to provide the voltage of the first node N1 having the low level L to the control node NQ. Therefore, the voltage of the control node NQ may have the low level L.

In the first duration DU1 of the high luminance mode, the fourteenth transistor T14 may be turned off in response to the voltage of the inversion control node NQB having the high level H.

In the first duration DU1 of the high luminance mode, the fifteenth transistor T15 may be turned on in response to the voltage of the control node NQ having the low level L to provide the low gate voltage VGL to the emission output node NEM. Therefore, the emission signal EM may have the low level L.

Since the voltage of the control node NQ has the low level L and the voltage of the third node N3 has the high level H, the first capacitor C1 may store the difference between the high level H and the low level L. Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the high level H, the third capacitor C3 may not store the voltage difference.

Referring to FIGS. 6B and 6D, in a second duration DU2 of the high luminance mode, the input signal IN may have the low level L, the first clock signal CLK1 may have the high level H, and the second clock signal CLK2 may have the low level L.

In the second duration DU2 of the high luminance mode, the first transistor T1 may be turned off in response to the first clock signal CLK1 having the high level H. Therefore, the voltage of the first node N1 may maintain the low level L.

In the second duration DU2 of the high luminance mode, the second transistor T2 may be turned on in response to the voltage of the first node N1 having the low level L to provide the first clock signal CLK1 having the high level H to the second node N2. Therefore, the voltage of the second node N2 may have the high level H.

In the second duration DU2 of the high luminance mode, the third transistor T3 may be turned off in response to the first clock signal CLK1 having the high level H.

In the second duration DU2 of the high luminance mode, the fourth transistor T4 may be turned off in response to the voltage of the second node N2 having the high level H.

In the second duration DU2 of the high luminance mode, the fifth transistor T5 may be turned on in response to the voltage of the first node N1 having the low level L to provide the second clock signal CLK2 having the low level L to the third node N3. Therefore, the voltage of the third node N3 may have the low level L.

In the second duration DU2 of the high luminance mode, the sixth transistor T6 may be turned on in response to the low gate voltage VGL to provide the voltage of the second node N2 having the high level H to the fourth node N4. Therefore, the voltage of the fourth node N4 may have the high level H.

In the second duration DU2 of the high luminance mode, the seventh transistor T7 may be turned off in response to the voltage of the fourth node N4 having the high level H.

In the second duration DU2 of the high luminance mode, the eighth transistor T8 may be turned on in response to the second clock signal CLK2 having the low level L to provide the voltage of the fifth node N5 having the high level H to the inversion control node NQB. Therefore, the voltage of the inversion control node NQB may have the high level H.

In the second duration DU2 of the high luminance mode, the ninth transistor T9 may be turned off in response to the first selection signal SEL1 having the high level H.

In the second duration DU2 of the high luminance mode, the tenth transistor T10 may be turned off in response to the reset signal ESR having the high level H.

In the second duration DU2 of the high luminance mode, the eleventh transistor T11 may be turned on in response to the second selection signal SEL2 having the low level L to provide the high gate voltage VGH to the first electrode of the twelfth transistor T12.

In the second duration DU2 of the high luminance mode, the twelfth transistor T12 may be turned on in response to the voltage of the first node N1 having the low level L to provide the voltage of the first electrode of the twelfth transistor T12 having the high level H to the inversion control node NQB. Therefore, the voltage of the inversion control node NQB may have the high level H.

In the second duration DU2 of the high luminance mode, the thirteenth transistor T13 may be turned on in response to the low gate voltage VGL to provide the voltage of the first node N1 having the low level L to the control node NQ. Therefore, the voltage of the control node NQ may have the low level L.

In the second duration DU2 of the high luminance mode, the fourteenth transistor T14 may be turned off in response to the voltage of the inversion control node NQB having the high level H.

In the second duration DU2 of the high luminance mode, the fifteenth transistor T15 may be turned on in response to the voltage of the control node NQ having the low level L to provide the low gate voltage VGL to the emission output node NEM. Therefore, the emission signal EM may have the low level L.

Since the voltage of the control node NQ has the low level L and the voltage of the third node N3 has the low level L, the first capacitor C1 may not store a voltage difference.

Since the voltage of the fourth node N4 has the high level H and the voltage of the fifth node N5 has the high level H, the second capacitor C2 may not store the voltage difference.

Since the first electrode of the third capacitor C3 has the high level H and the voltage of the inversion control node NQB has the high level H, the third capacitor C3 may not store the voltage difference.

Referring to FIGS. 6B and 6E, in a third duration DU3 of the high luminance mode, the input signal IN may have the high level H, the first clock signal CLK1 may have the low level L, and the second clock signal CLK2 may have the high level H.

In the third duration DU3 of the high luminance mode, the first transistor T1 may be turned on in response to the first clock signal CLK1 having the low level L to provide the input signal IN having the high level H to the first node N1. Therefore, the voltage of the first node N1 may have the high level H.

In the third duration DU3 of the high luminance mode, the second transistor T2 may be turned off in response to the voltage of the first node N1 having the high level H.

In the third duration DU3 of the high luminance mode, the third transistor T3 may be turned on in response to the first clock signal CLK1 having the low level L to provide the low gate voltage VGL to the second node N2. Therefore, the voltage of the second node N2 may have the low level L.

In the third duration DU3 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the third duration DU3 of the high luminance mode, the fifth transistor T5 may be turned off in response to the voltage of the first node N1 having the high level H.

In the third duration DU3 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the third duration DU3 of the high luminance mode, the seventh transistor T7 may be turned on in response to the voltage of the fourth node N4 having the low level L to provide the second clock signal CLK2 having the high level H to the fifth node N5. Therefore, the voltage of the fifth node N5 may have the high level H.

In the third duration DU3 of the high luminance mode, the eighth transistor T8 may be turned off in response to the second clock signal CLK2 having the high level H.

In the third duration DU3 of the high luminance mode, the ninth transistor T9 may be turned off in response to the first selection signal SEL1 having the high level H.

In the third duration DU3 of the high luminance mode, the tenth transistor T10 may be turned off in response to the reset signal ESR having the high level H.

In the third duration DU3 of the high luminance mode, the eleventh transistor T11 may be turned on in response to the second selection signal SEL2 having the low level L to provide the high gate voltage VGH to the first electrode of the twelfth transistor T12.

In the third duration DU3 of the high luminance mode, the twelve transistor T12 may be turned off in response to the voltage of the first node N1 having the high level H.

In the third duration DU3 of the high luminance mode, the thirteenth transistor T13 may be turned on in response to the low gate voltage VGL to provide the voltage of the first node N1 having the high level H to the control node NQ. Therefore, the voltage of the control node NQ may have the high level H.

In the third duration DU3 of the high luminance mode, the fourteenth transistor T14 may be turned off in response to the voltage of the inversion control node NQB having the high level H.

In the third duration DU3 of the high luminance mode, the fifteenth transistor T15 may be turned off in response to the voltage of the control node NQ having the high level H. Therefore, the emission signal EM may maintain the low level L.

Since the voltage of the control node NQ has the high level H and the voltage of the third node N3 has the high level H, the first capacitor C1 may not store the voltage difference.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the high level H, the third capacitor C3 may not store the voltage difference.

Referring to FIGS. 6B and 6F, in a fourth duration DU4 of the high luminance mode, the input signal IN may have the high level H, the first clock signal CLK1 may have the high level H, and the second clock signal CLK2 may have the low level L.

In the fourth duration DU4 of the high luminance mode, the first transistor T1 may be turned off in response to the first clock signal CLK1 having the high level H. Therefore, the voltage of the first node N1 may maintain the high level H.

In the fourth duration DU4 of the high luminance mode, the second transistor T2 may be turned off in response to the voltage of the first node N1 having the high level H.

In the fourth duration DU4 of the high luminance mode, the third transistor T3 may be turned off in response to the first clock signal CLK1 having the high level H. Therefore, the voltage of the second node N2 may maintain the low level L.

In the fourth duration DU4 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the fourth duration DU4 of the high luminance mode, the fifth transistor T5 may be turned off in response to the voltage of the first node N1 having the high level H.

In the fourth duration DU4 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the fourth duration DU4 of the high luminance mode, the seventh transistor T7 may be turned on in response to the voltage of the fourth node N4 having the low level L to provide the second clock signal CLK2 having the low level L to the fifth node N5.

In this case, when the second clock signal CLK2 changes from the high level H to the low level L and the voltage of the fifth node N5 changes from the high level H to the low level L, the voltage of the fourth node N4 may be bootstrapped by the second capacitor C2. Therefore, the voltage of the fourth node N4 may change from the low level L to a second low level L2 less than the low level L.

When the voltage of the fourth node N4 has the second low level L2 less than the low level L, the sixth transistor T6 may not provide the voltage of the fourth node N4 having the second low level L2 to the second node N2. Therefore, the voltage of the second node N2 may maintain the low level L, and the voltage of the fourth node N4 may maintain the second low level L2.

In the fourth duration DU4 of the high luminance mode, the eighth transistor T8 may be turned on in response to the second clock signal CLK2 having the low level L to provide the voltage of the fifth node N5 having the low level L to the inversion control node NQB. Therefore, the voltage of the inversion control node NQB may have the low level L.

In the fourth duration DU4 of the high luminance mode, the ninth transistor T9 may be turned off in response to the first selection signal SEL1 having the high level H.

In the fourth duration DU4 of the high luminance mode, the tenth transistor T10 may be turned off in response to the reset signal ESR having the high level H.

In the fourth duration DU4 of the high luminance mode, the eleventh transistor T11 may be turned on in response to the second selection signal SEL2 having the low level L to provide the high gate voltage VGH to the first electrode of the twelfth transistor T12.

In the fourth duration DU4 of the high luminance mode, the twelve transistor T12 may be turned off in response to the voltage of the first node N1 having the high level H.

In the fourth duration DU4 of the high luminance mode, the thirteenth transistor T13 may be turned on in response to the low gate voltage VGL to provide the voltage of the first node N1 having the high level H to the control node NQ. Therefore, the voltage of the control node NQ may have the high level H.

In the fourth duration DU4 of the high luminance mode, the fourteenth transistor T14 may be turned on in response to the voltage of the inversion control node NQB having the low level L to provide the high gate voltage VGH to the emission output node NEM. Therefore, the emission signal EM may have the high level H.

In the fourth duration DU4 of the high luminance mode, the fifteenth transistor T15 may be turned off in response to the voltage of the control node NQ having the high level H.

Since the voltage of the control node NQ has the high level H and the voltage of the third node N3 has the high level H, the first capacitor C1 may not store the voltage difference.

Since the voltage of the fourth node N4 has the second low level L2 and the voltage of the fifth node N5 has the low level L, the second capacitor C2 may store the difference between the low level L and the second low level L2.

Since the first electrode of the third capacitor C3 has the high level H and the voltage of the inversion control node NQB has the low level L, the third capacitor C3 may store the difference between the high level H and the low level L.

Referring to FIGS. 6B and 6G, in a fifth duration DU5 of the high luminance mode, the input signal IN may have the high level H, the first clock signal CLK1 may have the low level L, and the second clock signal CLK2 may have the high level H.

In the fifth duration DU5 of the high luminance mode, the first transistor T1 may be turned on in response to the first clock signal CLK1 having the low level L to provide the input signal IN having the high level H to the first node N1. Therefore, the voltage of the first node N1 may have the high level H.

In the fifth duration DU5 of the high luminance mode, the second transistor T2 may be turned off in response to the voltage of the first node N1 having the high level H.

In the fifth duration DU5 of the high luminance mode, the third transistor T3 may be turned on in response to the first clock signal CLK1 having the low level L to provide the low gate voltage VGL to the second node N2. Therefore, the voltage of the second node N2 may have the low level L.

In the fifth duration DU5 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the fifth duration DU5 of the high luminance mode, the fifth transistor T5 may be turned off in response to the voltage of the first node N1 having the high level H.

In the fifth duration DU5 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the fifth duration DU5 of the high luminance mode, the seventh transistor T7 may be turned on in response to the voltage of the fourth node N4 having the low level L to provide the second clock signal CLK2 having the high level H to the fifth node N5. Therefore, the voltage of the fifth node N5 may have the high level H.

In the fifth duration DU5 of the high luminance mode, the eighth transistor T8 may be turned off in response to the second clock signal CLK2 having the high level H.

In the fifth duration DU5 of the high luminance mode, the ninth transistor T9 may be turned off in response to the first selection signal SEL1 having the high level H.

In the fifth duration DU5 of the high luminance mode, the tenth transistor T10 may be turned off in response to the reset signal ESR having the high level H.

In the fifth duration DU5 of the high luminance mode, the eleventh transistor T11 may be turned on in response to the second selection signal SEL2 having the low level L to provide the high gate voltage VGH to the first electrode of the twelfth transistor T12.

In the fifth duration DU5 of the high luminance mode, the twelfth transistor T12 may be turned off in response to the voltage of the first node N1 having the high level H. Therefore, the voltage of the inversion control node NQB may maintain the low level L.

In the fifth duration DU5 of the high luminance mode, the thirteenth transistor T13 may be turned on in response to the low gate voltage VGL to provide the voltage of the first node N1 having the high level H to the control node NQ. Therefore, the voltage of the control node NQ may have the high level H.

In the fifth duration DU5 of the high luminance mode, the fourteenth transistor T14 may be turned on in response to the voltage of the inversion control node NQB having the low level L to provide the high gate voltage VGH to the emission output node NEM. Therefore, the emission signal EM may have the high level H.

In the fifth duration DU5 of the high luminance mode, the fifteenth transistor T15 may be turned off in response to the voltage of the control node NQ having the high level H.

Since the voltage of the control node NQ has the high level H and the voltage of the third node N3 has the high level H, the first capacitor C1 may not store the voltage difference.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the low level L, the third capacitor C3 may store the difference between the high level H and the low level L.

Referring to FIGS. 6B and 6H, in a sixth duration DU6 of the high luminance mode, the input signal IN may have the high level H, the first clock signal CLK1 may have the high level H, and the second clock signal CLK2 may have the low level L.

In the sixth duration DU6 of the high luminance mode, the first transistor T1 may be turned off in response to the first clock signal CLK1 having the high level H. Therefore, the voltage of the first node N1 may maintain the high level H.

In the sixth duration DU6 of the high luminance mode, the second transistor T2 may be turned off in response to the voltage of the first node N1 having the high level H.

In the sixth duration DU6 of the high luminance mode, the third transistor T3 may be turned off in response to the first clock signal CLK1 having the high level H. Therefore, the voltage of the second node N2 may maintain the low level L.

In the sixth duration DU6 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the sixth duration DU6 of the high luminance mode, the fifth transistor T5 may be turned off in response to the voltage of the first node N1 having the high level H.

In the sixth duration DU6 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the sixth duration DU6 of the high luminance mode, the seventh transistor T7 may be turned on in response to the voltage of the fourth node N4 having the low level L to provide the second clock signal CLK2 having the low level L to the fifth node N5.

In this case, when the second clock signal CLK2 changes from the high level H to the low level L and the voltage of the fifth node N5 changes from the high level H to the low level L, the voltage of the fourth node N4 may be bootstrapped by the second capacitor C2. Therefore, the voltage of the fourth node N4 may be changed from the low level L to a second low level L2 less than the low level L.

When the voltage of the fourth node N4 has the second low level L2 less than the low level L, the sixth transistor T6 may not provide the voltage of the fourth node N4 having the second low level L2 to the second node N2. Therefore, the voltage of the second node N2 may maintain the low level L, and the voltage of the fourth node N4 may maintain the second low level L2.

In the sixth duration DU6 of the high luminance mode, the eighth transistor T8 may be turned on in response to the second clock signal CLK2 having the low level L to provide the voltage of the fifth node N5 having the low level L to the inversion control node NQB. Therefore, the voltage of the inversion control node NQB may have the low level L.

In the sixth duration DU6 of the high luminance mode, the ninth transistor T9 may be turned off in response to the first selection signal SEL1 having the high level H.

In the sixth duration DU6 of the high luminance mode, the tenth transistor T10 may be turned off in response to the reset signal ESR having the high level H.

The eleventh transistor T11 may be turned on in response to the second selection signal SEL2 having the low level L to provide the high gate voltage VGH to the first electrode of the twelfth transistor T12.

In the sixth duration DU6 of the high luminance mode, the twelfth transistor T12 may be turned off in response to the voltage of the first node N1 having the high level H.

In the sixth duration DU6 of the high luminance mode, the thirteenth transistor T13 may be turned on in response to the low gate voltage VGL to provide the voltage of the first node N1 having the high level H to the control node NQ. Therefore, the voltage of the control node NQ may have the high level H.

In the sixth duration DU6 of the high luminance mode, the fourteenth transistor T14 may be turned on in response to the voltage of the inversion control node NQB having the low level L to provide the high gate voltage VGH to the emission output node NEM. Therefore, the emission signal EM may have the high level H.

In the sixth duration DU6 of the high luminance mode, the fifteenth transistor T15 may be turned off in response to the voltage of the control node NQ having the high level H.

Since the voltage of the control node NQ has the high level H and the voltage of the third node N3 has the high level H, the first capacitor C1 may not store the voltage difference.

Since the voltage of the fourth node N4 has the second low level L2 and the voltage of the fifth node N5 has the low level L, the second capacitor C2 may store the difference between the low level L and the second low level L2.

Since the first electrode of the third capacitor C3 has the high level H and the voltage of the inversion control node NQB has the low level L, the third capacitor C3 may store the difference between the high level H and the low level L.

Referring to FIG. 6B and FIG. 6I, in a seventh duration DU7 of the high luminance mode, the input signal IN may have the low level L, the first clock signal CLK1 may have the low level L, and the second clock signal CLK2 may have the high level H.

In the seventh duration DU7 of the high luminance mode, the first transistor T1 may be turned on in response to the first clock signal CLK1 having the low level L to provide the input signal IN having the low level L to the first node N1. Therefore, the voltage of the first node N1 may have the low level L.

In the seventh duration DU7 of the high luminance mode, the second transistor T2 may be turned on in response to the voltage of the first node N1 having the low level L to provide the first clock signal CLK1 having the low level L to the second node N2. Therefore, the voltage of the second node N2 may have the low level L.

In the seventh duration DU7 of the high luminance mode, the third transistor T3 may be turned on in response to the first clock signal CLK1 having the low level L to provide the low gate voltage VGL to the second node N2. Therefore, the voltage of the second node N2 may have the low level L.

In the seventh duration DU7 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the seventh duration DU7 of the high luminance mode, the fifth transistor T5 may be turned on in response to the voltage of the first node N1 having the low level L to provide the second clock signal CLK2 having the high level H to the third node N3. Therefore, the voltage of the third node N3 may have the high level H.

In the seventh duration DU7 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the seventh duration DU7 of the high luminance mode, the seventh transistor T7 may be turned on in response to the voltage of the fourth node N4 having the low level L to provide the second clock signal CLK2 having the high level H to the fifth node N5. Therefore, the voltage of the fifth node N5 may have the high level H.

In the seventh duration DU7 of the high luminance mode, the eighth transistor T8 may be turned off in response to the second clock signal CLK2 having the high level H.

In the seventh duration DU7 of the high luminance mode, the ninth transistor T9 may be turned off in response to the first selection signal SEL1 having the high level H.

In the seventh duration DU7 of the high luminance mode, the tenth transistor T10 may be turned off in response to the reset signal ESR having the high level H.

In the seventh duration DU7 of the high luminance mode, the eleventh transistor T11 may be turned on in response to the second selection signal SEL2 having the low level L to provide the high gate voltage VGH to the first electrode of the twelfth transistor T12.

In the seventh duration DU7 of the high luminance mode, the twelfth transistor T12 may be turned on in response to the voltage of the first node N1 having the low level L to provide the voltage of the first electrode of the twelfth transistor T12 having the high level H to the inversion control node NQB. Therefore, the voltage of the inversion control node NQB may have the high level H.

In the seventh duration DU7 of the high luminance mode, the thirteenth transistor T13 may be turned on in response to the low gate voltage VGL to provide the voltage of the first node N1 having the low level L to the control node NQ. Therefore, the voltage of the control node NQ may have the low level L.

In the seventh duration DU7 of the high luminance mode, the fourteenth transistor T14 may be turned off in response to the voltage of the inversion control node NQB having the high level H.

In the seventh duration DU7 of the high luminance mode, the fifteenth transistor T15 may be turned on in response to the voltage of the control node NQ having the low level L greater than the second low level L2 to provide a middle low level L_M greater than the low gate voltage VGL to the emission output node NEM. Therefore, the emission signal EM may have the middle low level L_M.

Since the voltage of the control node NQ has the low level L and the voltage of the third node N3 has the high level H, the first capacitor C1 may store the difference between the high level H and the low level L.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the high level H, the third capacitor C3 may not store the voltage difference.

Referring to FIGS. 6B and 6J, in an eighth duration DU8 of the high luminance mode, the input signal IN may have the low level L, the first clock signal CLK1 may have the high level H, and the second clock signal CLK2 may have the low level L.

In the eighth duration DU8 of the high luminance mode, the first transistor T1 may be turned off in response to the first clock signal CLK1 having the high level H. Therefore, the voltage of the first node N1 may maintain the low level L.

In the eighth duration DU8 of the high luminance mode, the second transistor T2 may be turned on in response to the voltage of the first node N1 having the low level L to provide the first clock signal CLK1 having the high level H to the second node N2. Therefore, the voltage of the second node N2 may have the high level H.

In the eighth duration DU8 of the high luminance mode, the third transistor T3 may be turned off in response to the first clock signal CLK1 having the high level H.

In the eighth duration DU8 of the high luminance mode, the fourth transistor T4 may be turned off in response to the voltage of the second node N2 having the high level H.

In the eighth duration DU8 of the high luminance mode, the fifth transistor T5 may be turned on in response to the voltage of the first node N1 having the low level L to provide the second clock signal CLK2 having the high level H to the third node N3. Therefore, the voltage of the third node N3 may have the low level L.

In this case, when the second clock signal CLK2 changes from the high level H to the low level L and the voltage of the third node N3 changes from the high level H to the low level L, the voltage of the control node NQ may be bootstrapped by the first capacitor C1. Therefore, the voltage of the control node NQ may be changed from the low level L to a second low level L2 less than the low level L.

In the eighth duration DU8 of the high luminance mode, the sixth transistor T6 may be turned on in response to the low gate voltage VGL to provide the voltage of the second node N2 having the high level H to the fourth node N4. Therefore, the voltage of the fourth node N4 may have the high level H.

In the eighth duration DU8 of the high luminance mode, the seventh transistor T7 may be turned off in response to the voltage of the fourth node N4 having the high level H.

In the eighth duration DU8 of the high luminance mode, the ninth transistor T9 may be turned off in response to the first selection signal SEL1 having the high level H.

In the eighth duration DU8 of the high luminance mode, the eighth transistor T8 may be turned on in response to the second clock signal CLK2 having the low level L to provide the voltage of the inversion control node NQB having the high level H to the fifth node N5. Therefore, the voltage of the fifth node N5 may have the high level H.

In the eighth duration DU8 of the high luminance mode, the tenth transistor T10 may be turned off in response to the reset signal ESR having the high level H.

In the eighth duration DU8 of the high luminance mode, the eleventh transistor T11 may be turned on in response to the second selection signal SEL2 having the low level L to provide the high gate voltage VGH to the first electrode of the twelfth transistor T12.

In the eighth duration DU8 of the high luminance mode, the twelfth transistor T12 may be turned on in response to the voltage of the first node N1 having the low level L to provide the voltage of the first electrode of the twelfth transistor T12 having the high level H to the inversion control node NQB. Therefore, the voltage of the inversion control node NQB may have the high level H.

When the voltage of the control node NQ has the second low level L2 less than the low level L, the thirteenth transistor T13 may not provide the voltage of the control node NQ having the second low level L2 to the first node N1. Therefore, the voltage of the first node N1 may maintain the low level L, and the voltage of the control node NQ may maintain the second low level L2.

In the eighth duration DU8 of the high luminance mode, the fourteenth transistor T14 may be turned off in response to the voltage of the inversion control node NQB having the high level H.

In the eighth duration DU8 of the high luminance mode, the fifteenth transistor T15 may be sufficiently turned on in response to the voltage of the control node NQ having the second low level L2 to provide the second clock signal CLK2 having the low level L to the emission output node NEM. Therefore, the emission signal EM may have the low level L.

Since the voltage of the control node NQ has the second low level L2 and the voltage of the third node N3 has the low level L, the first capacitor C1 may store the difference between the low level L and the second low level L2. In an embodiment, for example, the difference between the low level L and the second low level L2 may be equal to the difference between the high level H and the low level L.

Since the voltage of the fourth node N4 has the high level H and the voltage of the fifth node N5 has the high level H, the second capacitor C2 may not store the voltage difference.

Since the first electrode of the third capacitor C3 has the high level H and the voltage of the inversion control node NQB has the high level H, the third capacitor C3 may not store the voltage difference.

Referring to FIGS. 6B and 6K, in a ninth duration DU9 of the high luminance mode, the input signal IN may have the low level L, the first clock signal CLK1 may have the low level L, and the second clock signal CLK2 may have the high level H.

In the ninth duration DU9 of the high luminance mode, the first transistor T1 may be turned on in response to the first clock signal CLK1 having the low level L to provide the input signal IN having the low level L to the first node N1. Therefore, the voltage of the first node N1 may have the low level L.

In the ninth duration DU9 of the high luminance mode, the second transistor T2 may be turned on in response to the voltage of the first node N1 having the low level L to provide the first clock signal CLK1 having the low level L to the second node N2. Therefore, the voltage of the second node N2 may have the low level L.

In the ninth duration DU9 of the high luminance mode, the third transistor T3 may be turned on in response to the first clock signal CLK1 having the low level L to provide the low gate voltage VGL to the second node N2. Therefore, the voltage of the second node N2 may have the low level L.

In the ninth duration DU9 of the high luminance mode, the fourth transistor T4 may be turned on in response to the voltage of the second node N2 having the low level L to provide the high gate voltage VGH to the third node N3. Therefore, the voltage of the third node N3 may have the high level H.

In the ninth duration DU9 of the high luminance mode, the fifth transistor T5 may be turned on in response to the voltage of the first node N1 having the low level L to provide the second clock signal CLK2 having the high level H to the third node N3. Therefore, the voltage of the third node N3 may have the high level H.

In the ninth duration DU9 of the high luminance mode, the sixth transistor T6 may be turned on in response to the low gate voltage VGL to provide the voltage of the second node N2 having the low level L to the fourth node N4. Therefore, the voltage of the fourth node N4 may have the low level L.

In the ninth duration DU9 of the high luminance mode, the seventh transistor T7 may be turned on in response to the voltage of the fourth node N4 having the low level L to provide the second clock signal CLK2 having the high level H to the fifth node N5. Therefore, the voltage of the fifth node N5 may have the high level H.

In the ninth duration DU9 of the high luminance mode, the eighth transistor T8 may be turned off in response to the second clock signal CLK2 having the high level H.

In the ninth duration DU9 of the high luminance mode, the ninth transistor T9 may be turned off in response to the first selection signal SEL1 having the high level H.

In the ninth duration DU9 of the high luminance mode, the tenth transistor T10 may be turned off in response to the reset signal ESR having the high level H.

In the ninth duration DU9 of the high luminance mode, the eleventh transistor T11 may be turned on in response to the second selection signal SEL2 having the low level L to provide the high gate voltage VGH to the first electrode of the twelfth transistor T12.

In the ninth duration DU9 of the high luminance mode, the twelfth transistor T12 may be turned on in response to the voltage of the first node N1 having the low level L to provide the voltage of the first electrode of the twelfth transistor T12 having the high level H to the inversion control node NQB. Therefore, the voltage of the inversion control node NQB may have the high level H.

In the ninth duration DU9 of the high luminance mode, the thirteenth transistor T13 may be turned on in response to the low gate voltage VGL to provide the voltage of the first node N1 having the low level L to the control node NQ. Therefore, the voltage of the control node NQ may have the low level L.

In the ninth duration DU9 of the high luminance mode, the fourteenth transistor T14 may be turned off in response to the voltage of the inversion control node NQB having the high level H.

In the ninth duration DU9 of the high luminance mode, the fifteenth transistor T15 may be turned on in response to the voltage of the control node NQ having the low level L to provide the low gate voltage VGL to the emission output node NEM. Therefore, the emission signal EM may have the low level L.

Since the voltage of the control node NQ has the low level L and the voltage of the third node N3 has the high level H, the first capacitor C1 may store the difference between the high level H and the low level L.

Since the voltage of the fourth node N4 has the low level L and the voltage of the fifth node N5 has the high level H, the second capacitor C2 may store the difference between the high level H and the low level L.

Since the first electrode of the third capacitor C3 has the high level H and the voltage of the inversion control node NQB has the high level H, the third capacitor C3 may not store the voltage difference.

In an embodiment, as described above, in the high luminance mode, the length of the low level L of the emission signal EM may be equal to or greater than 2 horizontal times. That is, the emission driver 160 may finely adjust a pulse width of the emission signal EM provided to a pixel including a light emitting element driven by an Impulse PAM method, such that a maximum luminance expressed by the light emitting element may be finely adjusted.

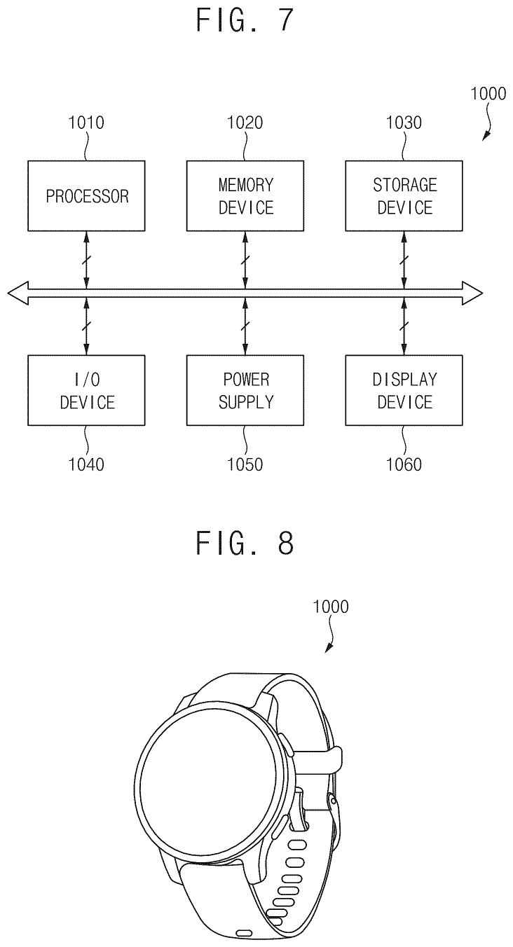

FIG. 7 is a block diagram showing an embodiment of an electronic device 1000. FIG. 8 is a diagram showing an embodiment in which an electronic device 1000 of FIG. 7 is implemented as a smart watch.

Referring to FIGS. 7 and 8, an embodiment of an electronic device 1000 may include a processor 1010, a memory device 1020, a storage device 1030, an input/output I/O device 1040, a power supply 1050, and a display device 10060. The display device 10060 may be the display device 100 of FIG. 1. In addition, the electronic device 1000 may further include a plurality of ports for communicating with a video card, a sound card, a memory card, a universal serial bus USB device, other electronic device, and the like.

In an embodiment, as shown in FIG. 8, the electronic device 1000 may be implemented as a smart watch. However, the electronic device 1000 is not limited thereto. In an embodiment, for example, the electronic device 1000 may be implemented as a cellular phone, a video phone, a smart pad, a smart phone, a tablet computer, a car navigation system, a computer monitor, a laptop computer, a head mounted display (HMD) device, and the like.

The processor 1010 may perform various computing functions. The processor 1010 may be a micro processor, a central processing unit (CPU), an application processor (AP), or the like. The processor 1010 may be coupled to other components via an address bus, a control bus, a data bus, and the like. Further, the processor 1010 may be coupled to an extended bus such as a peripheral component interconnection (PCI) bus.

The memory device 1020 may store data for operations of the electronic device 1000. In an embodiment, for example, the memory device 1020 may include at least one nonvolatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile (DRAM) device, and the like.

The storage device 1030 may include a solid state drive (SSD) device, a hard disk drive (HDD) device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 10060.

The power supply 1050 may provide power for operations of the electronic device 1000.

The display device 10060 may be connected to other components through buses or other communication links.

Embodiments of the invention may be applied to any display device and any electronic device including the touch panel. For example, embodiments of the invention may be applied to a mobile phone, a smart phone, a tablet computer, a digital television (TV), a three-dimensional (3D) TV, a personal computer (PC), a home appliance, a laptop computer, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An emission driver including a plurality of stages, wherein each of the stages comprises:
a first transistor including a gate electrode which receives a first clock signal, a first electrode which receives an input signal, and a second electrode connected to a first node;
a second transistor including a gate electrode connected to the first node, a first electrode which receives the first clock signal, and a second electrode connected to a second node;
a third transistor including a gate electrode which receives the first clock signal, a first electrode which receives a low gate voltage, and a second electrode connected to the second node;
a fourth transistor including a gate electrode connected to the second node, a first electrode which receives a high gate voltage, and a second electrode connected to a third node;
a fifth transistor including a first electrode connected to the first node, a first electrode which receives a second clock signal, and a second electrode connected to the third node;
a sixth transistor including a gate electrode which receives the low gate voltage, a first electrode connected to the second node, and a second electrode connected to a fourth node;
a seventh transistor including a gate electrode connected to the fourth node, a first electrode which receives the second clock signal, and a second electrode connected to a fifth node;
an eighth transistor including a gate electrode which receives the second clock signal, a first electrode connected to the fifth node, and a second electrode connected to an inversion control node;
a ninth transistor including a gate electrode which receives a first selection signal, a first electrode, and a second electrode connected to the inversion control node;
an eleventh transistor including a gate electrode which receives a second selection signal, a first electrode which receives the high gate voltage, and a second electrode;
a twelfth transistor including a gate electrode connected to the first node, a first electrode connected to the second electrode of the eleventh transistor, and a second electrode connected to the inversion control node;
a thirteenth transistor including a gate electrode which receives the low gate voltage, a first electrode connected to the first node, and a second electrode connected to a control node;
a fourteenth transistor including a gate electrode connected to the inversion control node, a first electrode which receives the high gate voltage, and a second electrode connected to an emission output node from which an emission signal is output; and
a fifteenth transistor including a gate electrode connected to the control node, a first electrode, and a second electrode connected to the emission output node.

2. The emission driver of claim 1, wherein each of the stages further comprises a tenth transistor including a gate electrode which receives a reset signal, a first electrode which receives the high gate voltage, and a second electrode connected to the first node.

3. The emission driver of claim 1, wherein each of the stages further comprises:
a first capacitor including a first electrode connected to the first node and a second electrode connected to the third node;
a second capacitor including a first electrode connected to the fourth node and a second electrode connected to the fifth node; and
a third capacitor including a first electrode which receives the high gate voltage and a second electrode connected to the inversion control node.

4. The emission driver of claim 1, wherein the first electrode of the ninth transistor is connected to the second node.

5. The emission driver of claim 4, wherein the first electrode of the ninth transistor is connected to the fourth node.

6. The emission driver of claim 4, wherein the ninth transistor and the eleventh transistor is a p-channel metal-oxide-semiconductor transistors.

7. The emission driver of claim 4, wherein the ninth transistor and the eleventh transistor are an n-channel metal-oxide-semiconductor transistors.

8. The emission driver of claim 7, wherein the ninth transistor includes two sub-transistors which are connected to each other in series and gate electrodes of which are connected to each other.

9. The emission driver of claim 7, wherein the eleventh transistor includes two sub-transistors which are connected in series and gate electrodes of which are connected to each other.

10. The emission driver of claim 7, wherein, in a low luminance mode, the first selection signal has an activation level, and the second selection signal has a deactivation level, and
wherein, in a high luminance mode, the first selection signal has the deactivation level, and the second selection signal has the activation level.

11. The emission driver of claim 7, wherein, in a low luminance mode, the first electrode of the fifteenth transistor receives the second clock signal, and
wherein in a high luminance mode, the first electrode of the fifteenth transistor receives the low gate voltage.

12. The emission driver of claim 1, wherein the input signal is an emission start signal or a previous emission signal,
wherein, in a low luminance mode, the emission start signal is a low luminance emission start signal, and
wherein, in a high luminance mode, the emission start signal is a high luminance emission start signal different from the low luminance emission start signal.

13. The emission driver of claim 12, wherein a length of a low level of the low luminance emission start signal is less than a length of a high level of the high luminance emission start signal.

14. The emission driver of claim 12, wherein a length of an activation level of the emission signal in the low luminance mode is less than a length of an activation level of the emission signal in the high luminance mode.

15. A display device comprising:
a display panel including a pixel;
a data driver which provides a data voltage to the pixel;
a gate driver which provides a gate signal to the pixel;
an emission driver which provides an emission signal to the pixel; and
a driving controller which controls the data driver, the gate driver, and the emission driver,
wherein the emission driver includes a plurality of stages, and
wherein each of the stages comprises:
a first transistor including a gate electrode which receives a first clock signal, a first electrode which receives an input signal, and a second electrode connected to a first node;
a second transistor including a gate electrode connected to the first node, a first electrode which receives the first clock signal, and a second electrode connected to a second node;
a third transistor including a gate electrode which receives the first clock signal, a first electrode which receives a low gate voltage, and a second electrode connected to the second node;
a fourth transistor including a gate electrode connected to the second node, a first electrode which receives a high gate voltage, and a second electrode connected to a third node;
a fifth transistor including a first electrode connected to the first node, a first electrode which receives a second clock signal, and a second electrode connected to the third node;
a sixth transistor including a gate electrode which receives the low gate voltage, a first electrode connected to the second node, and a second electrode connected to a fourth node;
a seventh transistor including a gate electrode connected to the fourth node, a first electrode which receives the second clock signal, and a second electrode connected to a fifth node;
an eighth transistor including a gate electrode which receives the second clock signal, a first electrode connected to the fifth node, and a second electrode connected to an inversion control node;
a ninth transistor including a gate electrode which receives a first selection signal, a first electrode, and a second electrode connected to the inversion control node;
an eleventh transistor including a gate electrode which receives a second selection signal, a first electrode which receives the high gate voltage, and a second electrode;
a twelfth transistor including a gate electrode connected to the first node, a first electrode connected to the second electrode of the eleventh transistor, and a second electrode connected to the inversion control node;
a thirteenth transistor including a gate electrode which receives the low gate voltage, a first electrode connected to the first node, and a second electrode connected to a control node;
a fourteenth transistor including a gate electrode connected to the inversion control node, a first electrode which receives the high gate voltage, and a second electrode connected to an emission output node from which an emission signal is output; and
a fifteenth transistor including a gate electrode connected to the control node, a first electrode, and a second electrode connected to the emission output node.

16. The display device of claim 15, wherein each of the stages further comprises a tenth transistor including a gate electrode which receives a reset signal, a first electrode which receives the high gate voltage, and a second electrode connected to the first node.

17. The display device of claim 15, wherein each of the stages further comprises:
a first capacitor including a first electrode connected to the first node and a second electrode connected to the third node;
a second capacitor including a first electrode connected to the fourth node and a second electrode connected to the fifth node; and
a third capacitor including a first electrode which receives the high gate voltage and a second electrode connected to the inversion control node.

18. The display device of claim 15, wherein the first electrode of the ninth transistor is connected to the second node.

19. The display device of claim 15, wherein the first electrode of the ninth transistor is connected to the fourth node.

20. An electronic device comprising:
a display panel including a pixel;
a data driver which provides a data voltage to the pixel;
a gate driver which provides a gate signal to the pixel;
an emission driver which provides an emission signal to the pixel;
a driving controller which controls the data driver, the gate driver, and the emission driver; and
a processor which controls the driving controller,
wherein the emission driver includes a plurality of stages, and
wherein each of the stages comprises:
a first transistor including a gate electrode which receives a first clock signal, a first electrode which receives an input signal, and a second electrode connected to a first node;
a second transistor including a gate electrode connected to the first node, a first electrode which receives the first clock signal, and a second electrode connected to a second node;
a third transistor including a gate electrode which receives the first clock signal, a first electrode which receives a low gate voltage, and a second electrode connected to the second node;
a fourth transistor including a gate electrode connected to the second node, a first electrode which receives a high gate voltage, and a second electrode connected to a third node;
a fifth transistor including a first electrode connected to the first node, a first electrode which receives a second clock signal, and a second electrode connected to the third node;
a sixth transistor including a gate electrode which receives the low gate voltage, a first electrode connected to the second node, and a second electrode connected to a fourth node;
a seventh transistor including a gate electrode connected to the fourth node, a first electrode which receives the second clock signal, and a second electrode connected to a fifth node;
an eighth transistor including a gate electrode which receives the second clock signal, a first electrode connected to the fifth node, and a second electrode connected to an inversion control node;
a ninth transistor including a gate electrode which receives a first selection signal, a first electrode, and a second electrode connected to the inversion control node;
an eleventh transistor including a gate electrode which receives a second selection signal, a first electrode which receives the high gate voltage, and a second electrode;
a twelfth transistor including a gate electrode connected to the first node, a first electrode connected to the second electrode of the eleventh transistor, and a second electrode connected to the inversion control node;
a thirteenth transistor including a gate electrode which receives the low gate voltage, a first electrode connected to the first node, and a second electrode connected to a control node;
a fourteenth transistor including a gate electrode connected to the inversion control node, a first electrode which receives the high gate voltage, and a second electrode connected to an emission output node from which an emission signal is output; and
a fifteenth transistor including a gate electrode connected to the control node, a first electrode, and a second electrode connected to the emission output node.
